(19) United States
(12) Patent Application Publication
(10) Pub. No.: US 2006/0155856 A1
(43) Pub. Date: Jul. 13, 2006

(54) Communications device, network system, communication management method, request signal, response signal, program, and recording medium containing the program

(75) Inventors: Ken Nakashima, Yamatokoriyama-shi (JP); Minoru Takemoto, Chiba-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka 545-8522 (JP)

(21) Appl. No.: 10/542,064

(22) PCT Filed: Jan. 9, 2004
(86) PCT No.: PCT/JP04/00127

§ 371 Date: Jul. 11, 2005

(30) Foreign Application Priority Data
Jan. 10, 2003 (JP) 2003-004078

(51) Int. Cl. G06F 15/16

(52) U.S. Cl. 709/227; 709/217

(57) ABSTRACT

A communications device (non-AP QSTA) transmits a request signal to a central control device (HC) so as to establish downlink stream communications from the central control device to the communications device. The request signal indicates a request for an ACK information specify process related to group ACK. The central control device receives, from the communications device, the request signal indicating a request for an ACK information specify process. The central control device transmits, to the communications device, a response signal to the request signal indicating a request for an ACK information specify process. The communications device receives the response signal from the central control device.

### TECHNICAL FIELD

The present invention relates to communications managing methods, communications devices, network systems, computer programs, and computer-readable storage media containing such programs to manage communications over a network where multiple communications devices share a single common network path.

### BACKGROUND ART

We have seen increasing importance of LANs (local area networks) in recent years. Communications stations connecting to the network share a single common medium for packet transmission. If two or more transmitting stations attempt transmissions at the same time, packets collision occurs. A mechanism needs be defined which efficiently prevents such collisions.

IEEE 802.11, a wireless LAN standard (ANSI/IEEE Std 802.11, 1999 Edition), for example, defines a CSMA/CA (carrier sense multiple access/collision avoidance)-based collision prevention scheme termed the DCF (distributed coordination function).

This conventional network gives an equal transmission right to all transmitting stations. An increase in the net traffic flow in the network results in a decrease in the bandwidth of each stream. This may pose a problem when movie, audio, and similar streams should be transferred in real time, because the “stream” allows only a restricted delay time in the transmission of each packet. When the network is busy, it fails to transmit the stream.

Various bandwidth securing mechanisms have been conceived for successful transmission of stream data. FIG. 17 shows a bandwidth securing technique as an example. According to the technique, a central control station 1203 on the network manages some of the bandwidth required for data transmission from a transmitting station (communications station) 1201 to a receiving station (communications station) 1202. Each transmitting station notifies the central control station of information on traffic characteristics of stream data before the stream is transferred over the network. The central control station determines whether the network is capable of a transfer of the stream. If the network is determined to be capable, the central control station assigns a transmission right to a transmitting station.

Concerning IEEE 802.11, a subgroup called the TGE is discussing a function of the central control station which enables wireless network bandwidth management. The function is termed the HCF (hybrid coordination function). In the draft scheme prepared by the TGE in the November, 2002 meeting (compliant with IEEE Std P802.11e/D4.0, 2002; hereinafter the “current draft”), a central control station termed an “HC (hybrid coordinator)” manages the transmission rights of some of the transmitting stations on the network. Non-HC communications satations are termed non-AP QSTA.

Upon receipt of a TSPEC (traffic specification) from non-AP QSTAs, the HC performs calculations (scheduling) relating to a sequence and times for assigning transmission rights to the transmitting stations so that the requests from the non-AP QSTAs are satisfied. The HC assigns transmission rights to the non-AP QSTAs based on results of the scheduling.

This process of registering a non-AP QSTA TSPEC with the HC is termed ADDTS. The HC and the non-AP QSTA are both capable of stream transmissions. In the following, the non-AP QSTA or HC which transmits a stream will be referred to as the stream transmitting station; the non-AP QSTA or HC which receives a stream will be referred to as the stream receiving station.

There are defined two techniques whereby receipt verification information is obtained from the receiving station in a data transmission. The techniques are termed normal ACK and group ACK.

Using a group ACK, receipt verification information for multiple packets can be sent together to the transmitting station. The group ACK provides better bandwidth efficiency, hence more effective in a HDTV stream transmission for example, than the normal ACK.

Group ACK can be either immediate group ACK or delayed group ACK.

In immediate group ACK, when requested by the stream transmitting station to send a group ACK, the stream receiving station must return a group ACK for multiple packets the station has received up to that moment. In delayed group ACK, in response to a request from the stream transmitting station to send a group ACK, the stream receiving station sends a group ACK for multiple packets the station has received up to that moment, when the station has obtained a transmission right next time.

Brief Description of ADDGA

The stream transmitting/receiving stations must exchange predetermined information in advance to use group ACK. The exchanged information can be divided into the following major categories:
1. Transmit buffer size. The size of a stream transmit buffer in the stream transmitting station. The information is sent from the stream transmitting station to the stream receiving station.
2. Re-ordering buffer size. This information provides the size of a stream receive buffer in the stream receiving station. It is sent from the stream receiving station to the stream transmitting station.
3. Group ACK policy. This is an indicator whether to use immediate group ACK or delayed group ACK. It is sent from the stream receiving station to the stream transmitting station.

To exchange the above information, the following procedures need be implemented.
Procedure I. The stream transmitting station transmits the stream receiving station a packet termed an ADDGA request frame. The packet includes a transmit buffer size.
Procedure II. The stream receiving station transmits the stream transmitting station a packet termed an ADDGA response frame. The packet includes a group ACK policy and a re-ordering buffer size.

This process is termed ADDGA.

FIG. 14 illustrates a wireless communications system involving multiple non-AP QSTAs and a HC. As shown in FIG. 14, IEEE 802.11 specifies the following three transmission schemes for different combinations of data transmission destinations:
Scheme I. This is for a downlink stream (from a HC 901 to a non-AP QSTA 902).
Scheme II. This is for an uplink stream (from the non-AP QSTA 902 to the HC 901).
Scheme III. This is for a direct link stream (from the non-AP QSTA 902 to another non-AP QSTA 903).

Both ADDTS and ADDGA must be completed before initiating a stream transmission using group ACK. The current draft specifies stations permitted to initiate ADDTS and ADDGA as follows:
In scheme I (downlink stream), ADDTS is initiated by the non-AP QSTA (stream receiving station) 902. ADDGA is initiated by the stream transmitting station (HC) 901.
In scheme II (uplink stream), ADDTS is initiated by the non-AP QSTA (stream transmitting station) 902. ADDGA is initiated by the stream transmitting station (non-AP QSTA) 902.
In scheme III (direct link stream), ADDTS is initiated by the non-AP QSTA (stream transmitting station) 902. ADDGA is initiated by the stream transmitting station (non-AP QSTA) 902.

The draft specifies that ADDTS shall be implemented before ADDGA. This is however not essential.

Details of ADDTS

ADDTS will be described in reference to FIG. 15. An SME (station management entity) manages the functions of a wireless station regardless of communication layer. A prefix “MLME-” indicates a service primitive provided to the SME by the MAC layer (more precisely, MLME-MAC sublayer management entity). In the description about both ADDTS and ADDGA (will be detailed later), the non-AP QSTA 1 is supposed to be the stream transmitting station, and the non-AP QSTA 2 the stream receiving station.

ADDTS is implemented for a direct link stream by the following steps.

Generation of TSPEC

The TSPEC is generated at the SME on the non-AP QSTA (stream transmitting station) 1 (step 1001).

MLME-ADDTS.request

The SME on the non-AP QSTA (stream transmitting station) 1 issues an MLME-ADDTS.request based on the TSPEC and other information as parameters (step 1002).

Transmission of ADDTS Request Frame

An ADDTS request frame is generated at the MAC on the non-AP QSTA (stream transmitting station) 1. The generated ADDTS request frame includes the TSPEC passed from the SME, a destination address, and other information. The request frame is transmitted to the HC (step 1003).

MLME-ADDTS.indication

The HC MAC analyzes the, incoming ADDTS request frame and sends an MLME-ADDTS.indication. As a result, the HC SME learns the TSPEC and other information obtained through the analysis at the MAC as parameters (step 1004).

Determining Whether the TSPEC is Acceptable

As the TSPEC is passed from the MAC, the HC SME determines whether the TSPEC is acceptable (step 1005). The determination is made in the consideration of a transmission of another stream. When there is already another stream occupying so much of the bandwidth that the remaining bandwidth is not sufficient to meet the requested TSPEC, for example, the HC SME determines that the TSPEC is not acceptable. Here, we suppose that the TSPEC is accepted.

MLME-ADDTS.response

The HC SME issues an MLME-ADDTS.response (step 1006). As a result, the MAC learns a result code, the TSPEC, and other information. The result code is a value which indicates whether the TSPEC is accepted, and if not accepted, also indicates the reasons for the rejection. If the result code indicates that the TSPEC is accepted, the TSPEC includes the same information as the information received in the ADDTS request frame.

Transmission of ADDTS Response Frame

An ADDTS response frame is generated at the HC MAC. The generated ADDTS response frame includes the TSPEC passed from the SME and the result code, as well as other information. The request frame is transmitted to the stream receiving station (step 1007).

MLME-ADDTS.confirm

The MAC on the non-AP QSTA (stream transmitting station) 1 analyzes the incoming ADDTS response frame and issues an MLME-ADDTS.confirm (step 1008). As a result, the SME of the receiving station learns the TSPEC and result code obtained through the analysis at the MAC, as well as other information, as parameters. Also, the SME learns a stream identifier termed a TID (traffic identifier) by which the MAC identifies the stream.

ADDTS for a direct link stream is executed by these steps.

Details of ADDGA

ADDGA will be described in reference to FIG. 16. ADDGA is implemented for a direct link stream by the following steps.

Determining Transmit-Buffer Size

The SME on the non-AP QSTA (stream transmitting station) 1 determines a transmit buffer size (step 1101).

MLME-ADDGA.request

The SME on the non-AP QSTA (stream transmitting station) 1 issues an MLME-ADDGA.request (step 1102). Parameters include the TID and transmit buffer size.

Transmission of ADDGA Request Frame

An ADDGA request frame is generated at the MAC on the non-AP QSTA (stream transmitting station) 1. The generated ADDGA request frame includes the TID and transmit buffer size passed from the SME, as well as other information. The request frame is transmitted to the non-AP QSTA (stream receiving station) 2 (step 1103).

MLME-ADDGA.indication

The MAC on the non-AP QSTA (stream receiving station) 2 analyzes the incoming ADDGA request frame and sends an MLME-ADDGA.indication (step 1104). From the MLME-ADDGA.indication, the SME on the non-AP QSTA (stream receiving station) 2 learns the TID, transmit buffer size, and other information.

Determining Whether to Use Group ACK

From the information in the MLME-ADDGA.indication, the SME on the non-AP QSTA (stream receiving station) 2 decides whether to use a group ACK (step 1105). A result code for am MLME-ADDGA.response is determined based on this decision. The result code is determined based on whether to use a group ACK, and if not, reasons for the non-use. If a decision is made that the group ACK will be used, the collected TID, transmit buffer size, and other information are stored for future use in an actual transmission of a group ACK.

Determining Group ACK Policy and Re-Ordering Buffer Size

The SME on the non-AP QSTA (stream receiving station) 2 determines a group ACK policy (step 1106). How the receiving station is implemented dictates whether to use an immediate group ACK or a delayed group ACK. Suppose here that the SME somehow obtained beforehand information as to which of the group ACK policies will be used.

The SME also determines a re-ordering buffer size (step 1106).

MLME-ADDGA.response

The SME on the non-AP QSTA (stream receiving station) 2 issues an MLME-ADDGA.response (step 1107). The MAC learns the TID, result code, group ACK policy, re-ordering buffer size, etc. as the parameters in the

MLME-ADDGA.response.

Transmission of ADDGA Response Frame

An ADDGA response frame is generated at the MAC on the non-AP QSTA (stream receiving station) 2. The generated ADDGA request frame includes the TID, result code, group ACK policy, re-ordering buffer size, and other information passed from the SME. The request frame is transmitted to the non-AP QSTA (stream transmitting station) 1 (step 1108).

MLME-ADDGA.confirm

The MAC on the non-AP QSTA (stream transmitting station) 1 analyzes the incoming ADDGA response frame and issues an MLME-ADDGA.confirm (step 1109). As a result, the SME learns the TID, result code, group ACK policy, re-ordering buffer size, etc.

ADDGA for a direct link stream is executed by these steps.

According to conventional art (Draft Supplement to Standard for Telecommunications and Information Exchange Between Systems-LAN/MAN Specific Requirements—Part 11: Wireless Medium Access Control (MAC) and Physical Layer (PHY) specifications: Medium Access Control (MAC) Enhancements for Quality of Service (QoS), IEEE Std 802.11e/D4.0, November 2002), the scheme II uplink stream and the scheme III direct link stream have no problems, because ADDTS and ADDGA are initiated by the same station in these schemes.

In the scheme I downlink stream, however, ADDTS and ADDGA are initiated by different stations, causing problems A and B:
Problem A. Neither the stream transmitting station nor the stream receiving station can trigger both ADDTS and ADDGA. If a single station initiated both ADDTS and ADDGA, that station could first complete either of the processes before going on to the other process. Actually, there are two stations involved initiating different processes. It is not clear when the stations should initiate the respective processes.
Problem B. A successful completion of either ADDTS or ADDGA cannot be verified before executing the other process. Both processes must be successfully completed to be useful. It is a waste to initiate a process when the other has failed.

The foregoing has described an example where problems occur because ADDTS and ADDGA are initiated by different stations. ADDTS and ADDGA are essential processes in a preparation for downlink stream communications. This is not the only problematic situation: similar problems can occur if different stations trigger different processes.

The present invention, conceived to address these problems, has an objective to provide a communications managing method which enables the data transmitting station or the data receiving station to singly trigger all processes, initiating a process after the completion of a preceding one, in order to efficiently complete preparation for a data transmission. The invention has other objectives to provide a related communications device, network system, request signal, response signal, computer program, and storage medium containing the computer program.

An exemplary communications managing method, communications device, network system, request signal, response signal, computer program, and storage medium containing the computer program enable the stream transmitting station or the stream receiving station to singly trigger both ADDTS and ADDGA processes in such a manner that either ADDTS or ADDGA is completed first before the other is initiated, in order to efficiently complete preparation for a stream transmission.

### DISCLOSURE OF INVENTION

A communications device in accordance with the present invention, to achieve the objectives, is characterized in that it is part of a network system involving multiple communications devices and a communications network connecting the devices. The communications device includes transmit means for transmitting signals from the communications device to another communications device. The signals are transmitted first in respective communications establish processes performed between the communications device and the other communications device so as to establish data communications between the communications device and the other communications device.

According to the arrangement, the communications device sends the other communications device all signals that should be transmitted first in respective communications establish processes performed between the communications device and the other communications device so as to establish data communications between the communications device and the other communications device.

Therefore, the communications device becomes the source for all signals that should be transmitted first.

Therefore, the communications device can determine alone when to initiate/trigger the communications establish processes. Therefore, the processes required to establish data communications can be done efficiently.

Another communications device in accordance with the present invention is characterized in that it is part of a network system involving multiple communications devices and a communications network connecting the devices. The communications device includes receive means for receiving signals from another communications device. The signals are transmitted first in respective communications establish processes performed between the communications device and the other communications device so as to establish data communications between the communications device and the other communications device. The communications device further includes transmit means for transmitting, to the other communications device, response signals respectively to the signals which are transmitted first.

According to the arrangement, the communications device receives, from the other communications device, all signals that should be transmitted first in respective communications establish processes performed between the communications device and the other communications device so as to establish data communications between the communications device and the other communications device. Further, the communications device sends the other communications device a response signal to each signal that should be transmitted first.

Therefore, the communications device becomes the destination for all signals that should be transmitted first. In other words, the other communications device becomes the source for all signals that should be transmitted first. Further, the other communications device can determine the status of the communications establish processes from the incoming response signals.

Therefore, the other communications device can determine alone when to initiate/trigger the communications establish processes. Therefore, the processes required to establish data communications can be done efficiently.

Another communications device in accordance with the present invention, to achieve the objectives, is characterized in that it is part of a network system involving multiple communications devices and a communications network connecting the devices. The communications device includes receive means for receiving a first request signal from another communications device so as to establish data communications between the communications device and the other communications device. The first request signal indicates a request for a first communications establish process. The communications device further includes: determine means for determining whether to accept the request in the first request signal; and transmit means for transmitting a second request signal indicating a request for a second communications establish process to the other communications device so as to establish data communications between the communications device and the other communications device. If the determine means has accepted the request, the transmit means transmits the second request signal to the other communications device.

According to the arrangement, the determine means determines whether to accept the request in the first request signal. If the determine means has accepted the request, the transmit means transmits the second request signal to the other communications device.

That is, the transmit means transmits the second request signal on a condition that the communications device has accepted the request.

Therefore, the communications device can by itself determine when to transmit the second request signal. That is, the second communications establish process can also be triggered by the transmission of the first request signal from the other communications device.

Therefore, the processes required to establish data communications can be done efficiently.

Another communications device in accordance with the present invention, to achieve the objectives, is characterized in that it is part of a network system involving multiple communications devices and a communications network connecting the devices. The communications device includes: transmit means for transmitting a request signal indicating a request for a predetermined communications establish process to another communications device so as to establish data communications between the communications device and the other communications device; receive means for receiving, from the other communications device, a response signal to the request signal; determine means for determining based on the response signal whether the predetermined communications establish process has been performed; and notify means for notifying the other communications device of a determination made by the determine means.

According to the arrangement, the notify means notifies the other communications device of a determination made by the determine means. That is, the communications device notifies the other communications device whether the first specify process has been done.

Therefore, the other communications device can recognize that the predetermined specify process has been done from the determination. The other communications device can determine when to initiate another communications establish process with respect to the communications device so as to establish data communications. That is, the other communications establish process can also be done by triggering a notification of the determination made by the communications device.

Therefore, the processes required to establish data communications can be done efficiently.

Additional objects, advantages and novel features of the invention will be set forth in part in the description which follows, and in part will become apparent to those skilled in the art upon examination of the following or may be learned by practice of the invention.

### BRIEF DESCRIPTION OF DRAWINGS

FIG. 1 is a timing chart illustrating a first embodiment of the present invention.

FIG. 2 is a drawing showing a first example of the packet format in accordance with the first embodiment of the present invention.

FIG. 3 is a drawing showing a second example of the packet format in accordance with the first embodiment of the present invention.

FIG. 4 is a timing chart illustrating a second embodiment of the present invention.

FIG. 5 is a timing chart illustrating a third embodiment of the present invention.

FIG. 6 is a drawing showing a device configuration in accordance with the first, second, and third embodiments of the present invention.

FIG. 7 is a block diagram illustrating a non-AP QSTA in accordance with the present invention.

FIG. 8 is a block diagram illustrating a HC in accordance with the present invention.

FIG. 9 is another timing chart illustrating the first embodiment.

FIG. 10 is a further timing chart illustrating the first embodiment.

FIG. 11 is another timing chart illustrating the second embodiment.

FIG. 12 is a further timing chart illustrating the second embodiment.

FIG. 13 is another timing chart illustrating the third embodiment.

FIG. 14 is a drawing showing a conventional data transmission scheme.

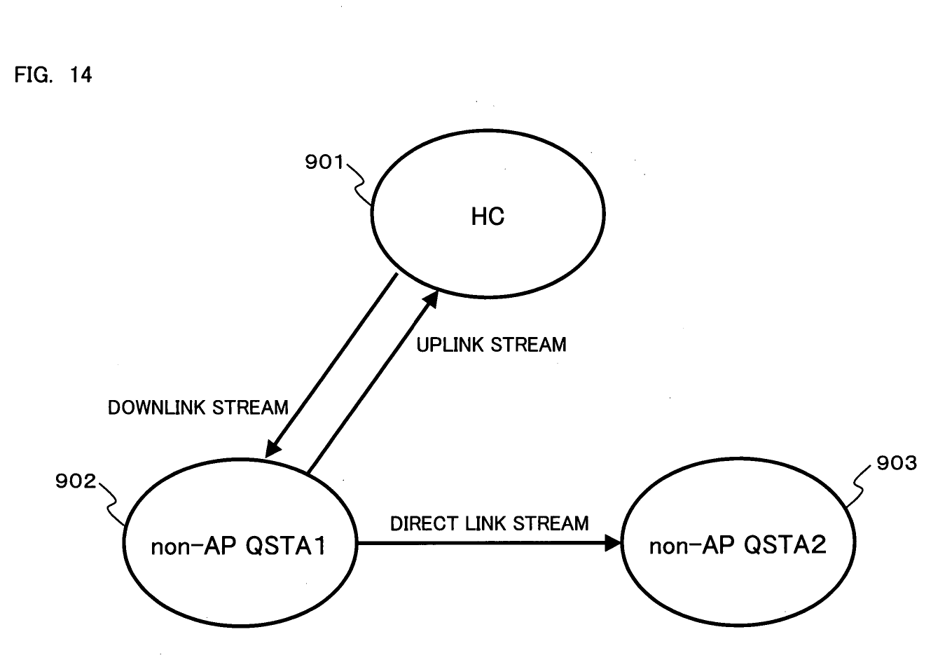

FIG. 15 is a timing chart illustrating conventional ADDTS.

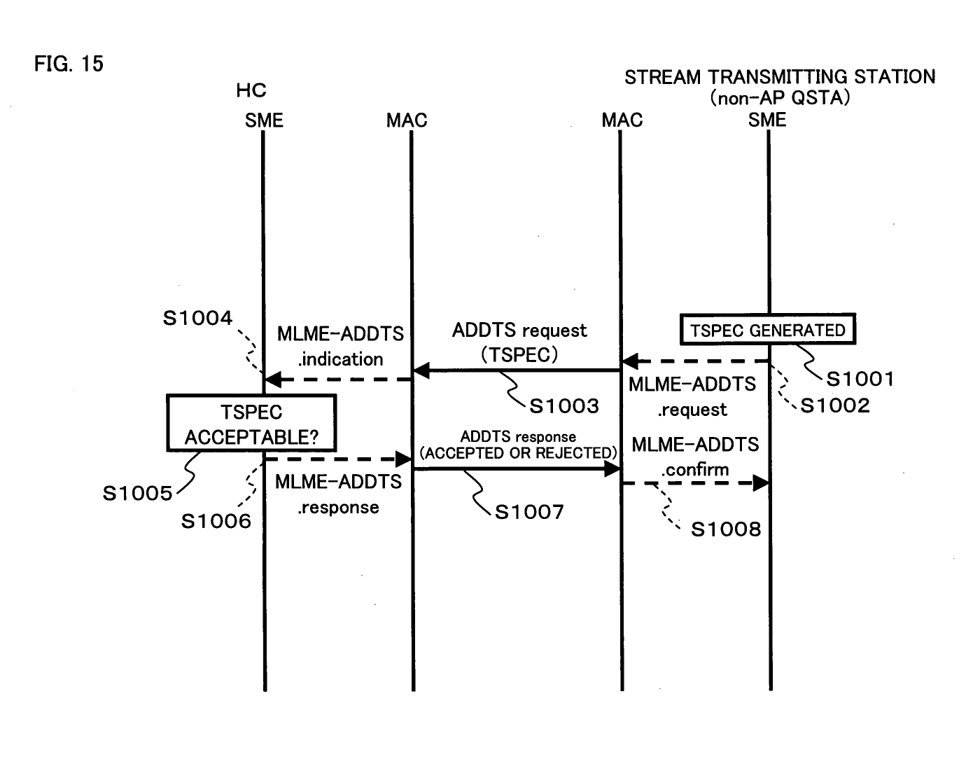

FIG. 16 is a timing chart illustrating conventional ADDGA.

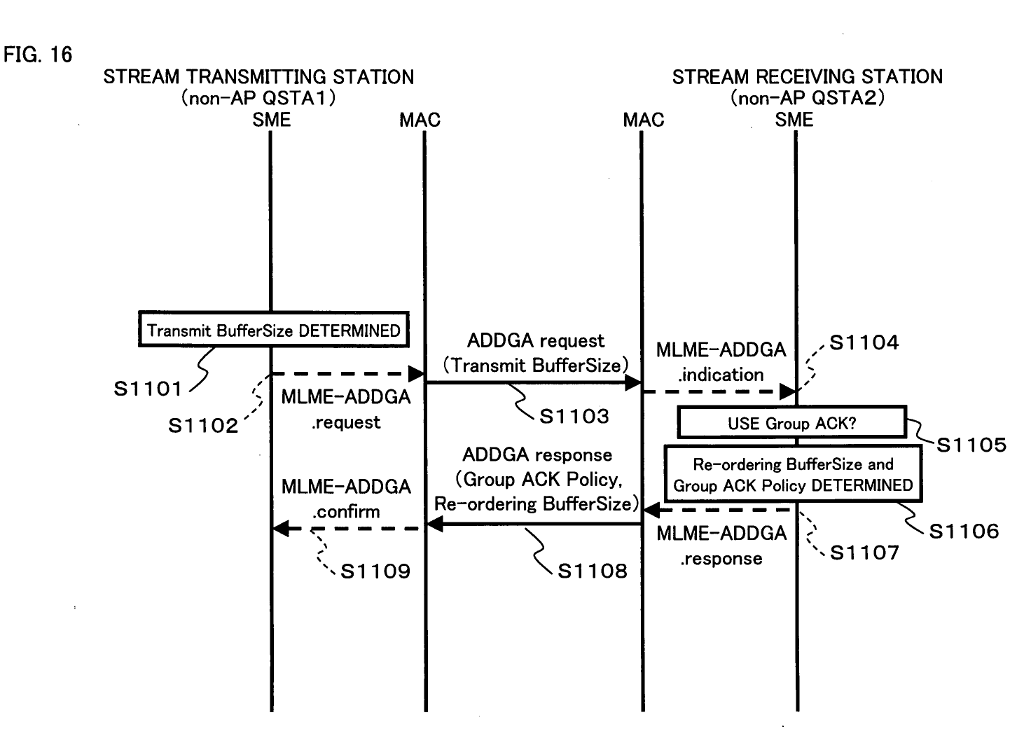

FIG. 17 is a drawing a conventional bandwidth management technique.

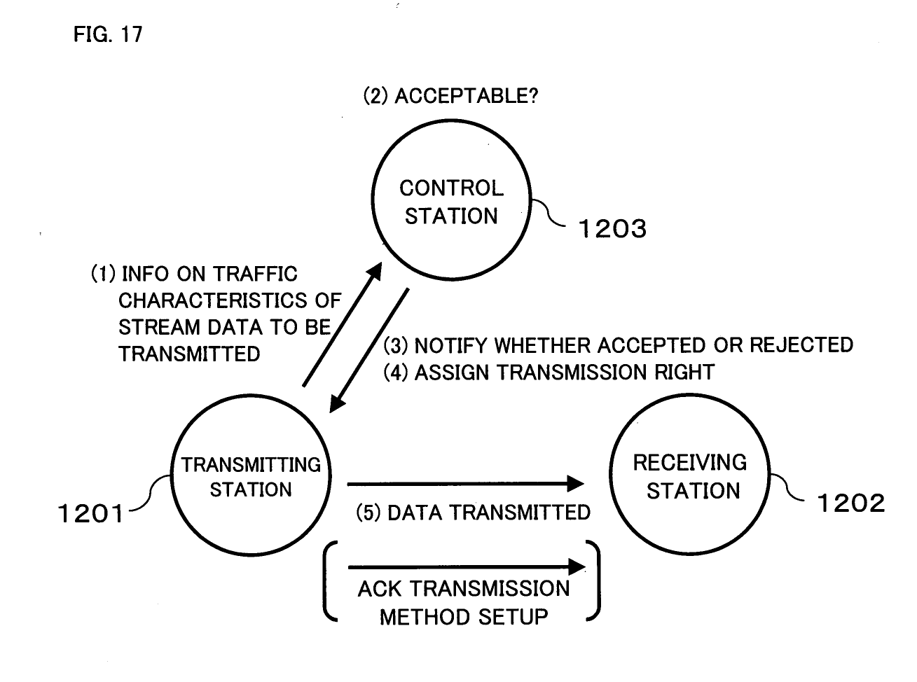

### BEST MODE FOR CARRYING OUT INVENTION

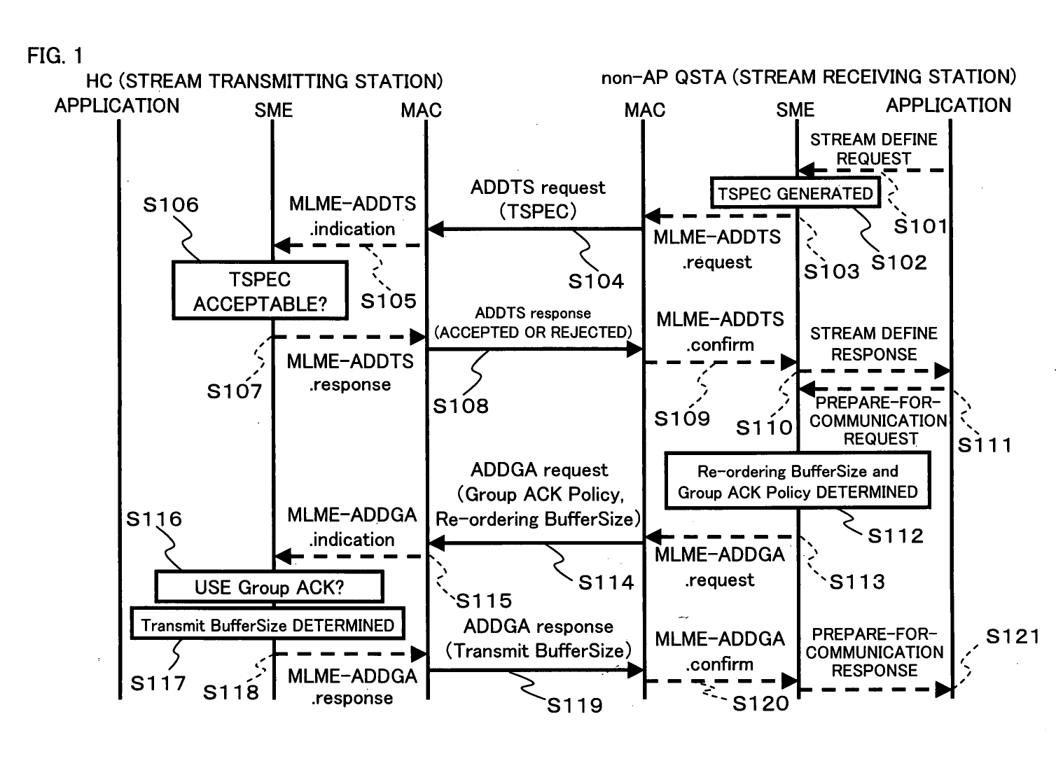

The following will describe embodiments of the present invention in reference to FIG. 1 through FIG. 13.

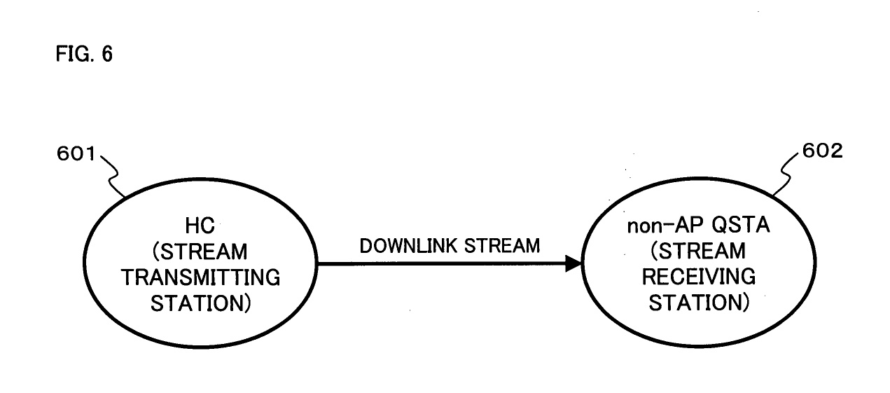

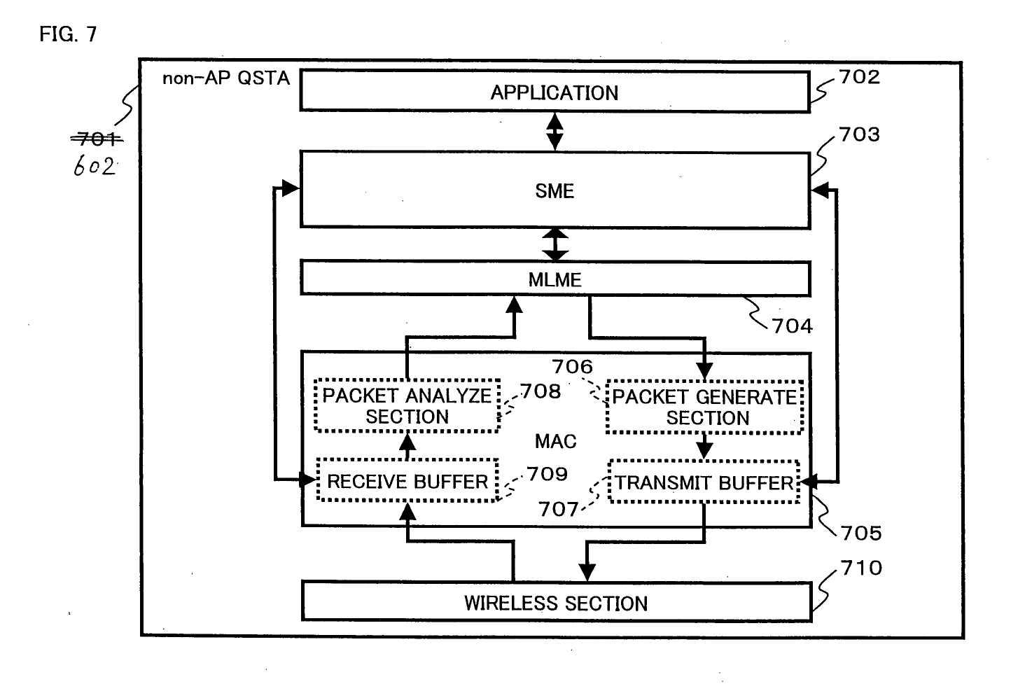

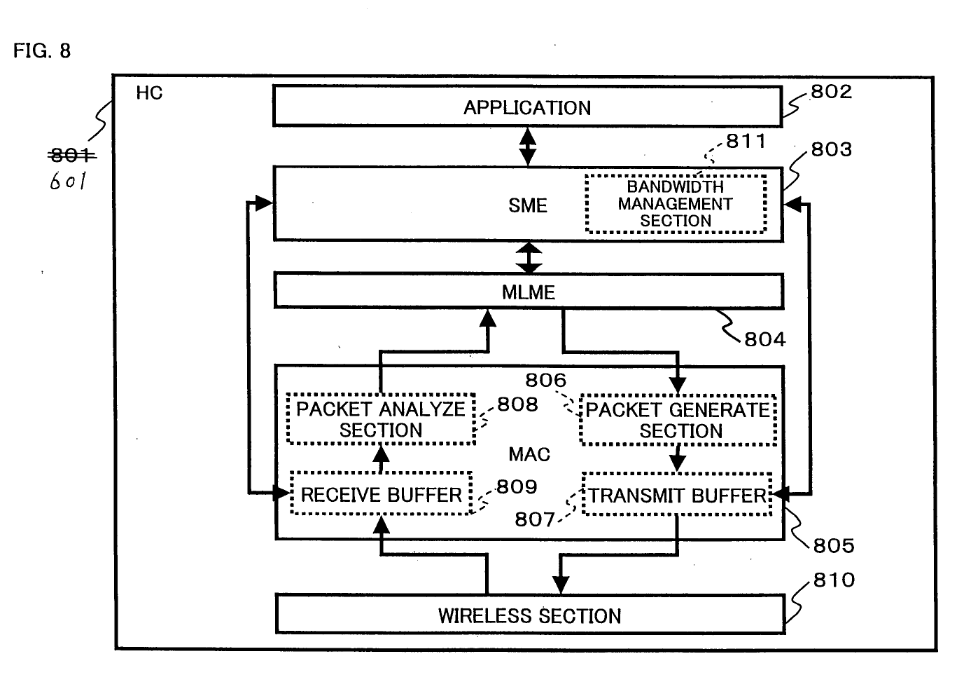

In the embodiments below, the present invention is applied to downlink stream transmissions according to IEEE Std 8.02.11e/D4.0, 2002. In such transmissions, the HC is the stream transmitting station, and the non-AP QSTA is the stream receiving station. The embodiments have the same device configuration which is shown in FIG. 6. FIG. 7 is a block diagram representing a non-AP QSTA 602 which is a stream receiving station. FIG. 8 is a block diagram representing a HC 601 which is a stream transmitting station.

The structure of the non-AP QSTA 602 will be first described in reference to FIG. 7.

An application 702, for example, instructs an SME 703 to initiate ADDTS and ADDGA and also instructs a MAC 705 to generate a stream and transmit the stream in the form of data packets. No route is shown for the transmission. The MAC 705 will be detailed later. A user controls the stream transmission basically through the manipulation of the application 702. The application is, for example, video transmission software running on a computer.

The SME 703 (station management entity) is an entity managing the functions of a wireless station regardless of communication layer.

An MLME 704 (MAC sublayer management entity) is an entity managing the operation of the MAC 705 which will be detailed later. The MLME 704 provides an interface between the SME 703 and the MAC 705. Specifically, the MLME provides a service primitive for each function. The SME 703 can use a function provided by the MAC 705 by specifying a service primitive. In specifying a service primitive, a parameter may be specified. Examples of the service primitive include an MLME-ADDTS.request, MLME-ADDTS.response, MLME-ADDTS.indication, MLME-ADDTS.confirm, MLME-ADDGA.request, MLME-ADDGA.response, MLME-ADDGA.indication, and MLME-ADDGA.confirm.

The MAC 705 generates packets in accordance with the function specified through a service primitive and instructs a wireless section 710 to transmit the packets. Information is exchanged between communications stations according to values recorded in packet fields, for communications control and stream transmission. The packets are, for example, an ADDTS request, ADDTS response, ADDGA request, and ADDGA response. The MAC 705 includes a packet generate section 706, a packet analyze section 708, a receive buffer 709, and a transmit buffer 707.

The wireless section 710 converts the packets generated at the MAC 705 as digital signals into wireless signals. The section 710 also converts incoming wireless signals into digital signals recognizable to the MAC 705.

Next, the structure of the HC 601 will be described in reference to FIG. 8.

The HC 601 has the same basic structure as the non-AP QSTA 602. They are different where the SME 803 has a bandwidth management section 811. The bandwidth management section 811 schedules a sequence and times for assigning transmission rights to the communications stations.

When the communications device is the communications station, the SME 703, MLME 704, packet generate section 706, and transmit buffer 707 together form an equivalent to the transmit means recited in claims. The packet generate section 706 and the transmit buffer 707 are provided at the MAC 705. Also, the SME 703, MLME 704, packet analyze section 708, and receive buffer 709 together form an equivalent to the receive means recited in claims. The packet analyze section 708 and the receive buffer 709 are provided at the MAC 705.

When the communications device is the central control station, the SME 803, MLME 804, packet generate section 806, and transmit buffer 807 together form an equivalent to the transmit means recited in claims. The packet generate section 806 and the transmit buffer 807 are provided at the MAC 805. The SME 803, MLME 804, packet analyze section 808, and receive buffer 809 together form an equivalent to the receive means recited in claims. The packet analyze section 808 and the receive buffer 809 are provided at the MAC 805.

### Embodiment 1

The present embodiment enables the stream transmitting station or the stream receiving station to singly trigger both ADDTS and ADDGA. There are two solutions to this issue:
Solution I whereby the HC is enabled to initiate ADDTS; and
Solution II whereby a non-AP QSTA is enabled to initiate ADDGA.

Solution I has negative effects. The present invention does not take this solution and discusses only solution II.

A simple approach to solution II results in following shortcomings.

Suppose that the stream receiving station initiates ADDGA after the same station executes ADDTS. In this situation, the stream receiving station must notify the stream transmitting station of a group ACK policy and a re-ordering buffer size. However, the current draft assumes that the ADDGA request frame is transmitted only from the stream transmitting station to the stream receiving station. The draft gives no field for such information.

Similarly, the stream transmitting station must notify the stream receiving station of a transmit buffer size. The ADDGA response frame, however, has no field for such information.

In other words, the stations cannot collect sufficient information required to complete ADDGA if the ADDGA request frame and the ADDGA response frame are exchanged as specified in the current draft.

Therefore, the present invention makes changes to the specifics given in the current draft. In both the ADDGA request frame and the ADDGA response frame, the present invention designates a field for information transferred from the stream transmitting station to the stream receiving station and another field for information transferred in the opposite direction.

Accordingly, the ADDGA request frame and the ADDGA response frame each contain a useless field. The present invention provides also a means of differentiating these useless fields from others. Now, we will describe the present invention in more specific terms.

The first embodiment of the, present invention is a method whereby the ADDGA request can originate also from the stream receiving station. This is achieved by including both the information transferred from the stream transmitting station to the stream receiving station and the information transferred, in the opposite direction in each of the ADDGA request and the ADDGA response. Accordingly, a single application triggers ADDGA and receives an end notification of ADDTS. The application can therefore verify completion of ADDTS before carrying out ADDGA.

Briefly, the overall operation flow goes like this: The application 702 on the stream receiving station 602 issues a stream define request. The ADDTS is subsequently completed. Upon receipt of a returned stream define response, the application 702 issues a prepare-for-communication request, and the stream receiving station 602 initiates ADDGA.

Next, this process will be described in detail in reference to FIGS. 1, 6, 7, and 8.

Stream Define Request

The application 702 on the non-AP QSTA (stream receiving station) 602 sends a stream define request to the SME 703 (step 101). The request contains an encoding format and a bit rate for the stream to be transmitted, as well as other information.

ADDTS

Thereafter, ADDTS is carried out between the non-AP QSTA (stream receiving station) 602 and the HC 601 (steps 102 to step 109). This process is basically the same as conventional technology. Description of details is omitted. To explain conventional technology, a direct link stream was taken as an example; therefore, the stream transmitting station performed ADDTS. The present embodiment deals with a downlink stream and hence differs where it is the stream receiving station 602 that performs ADDTS.

Stream Define Response

As the ADDTS ends, the SME 703 on the non-AP QSTA (stream receiving station) 602 sends a stream define response to the application (step 110). From this response, the application 702 learns a TID included in the TSPEC as stream identifying information.

The stream define response may include a result code passed from the MAC 705. The result code may be modified before being passed to the application. The SME 703 may possibly indicate only whether the HC 601 has accepted the TSPEC, for example. Alternatively, the SME 703 may send the stream define response only if the result code is a value indicating a success; if the result code is a value indicating a failure, the SME 703 may not send the stream define response. When this is the case, the application may determine that the stream define request has failed if the application does not receive a stream define response within a predetermined time after the stream define request.

If the ADDTS is determined to have failed, the SME 703 may execute the ADDTS again for the same stream, but at different transmission settings. For example, a request with a reduced bit rate results in less required bandwidth, which is more likely to be accepted by the bandwidth management section 811 of the HC 601. Alternatively, defining the same stream may be given up, to execute ADDTS for another stream. It is also possible to inform the user that the stream defining has failed and stands by awaiting a next command from the user. The user may also be informed of the cause of the failure.

Here, we suppose that the application has determined that the stream define request was successful.

Prepare-for-Communication Request

The application 702 on the non-AP QSTA (stream receiving station) 602 issues a prepare-for-communication request to the SME 703 (step 111). This request includes a TID so that the SME 703 can-determine for which stream the prepare-for-communication request is intended. This TID is the same as the one included in the stream define response. Only a preparation for the transmission/reception of a group ACK is done through the prepare-for-communication request in the present embodiment. A preparation for the transmission/reception of a stream may also be done the prepare-for-communication request.

The application 702 may also communicate information as to whether to use group ACK to the stream for which the prepare-for-communication request is issued. In addition, the application 702 may not indicate whether to use the group ACK; the SME 703 can determine whether to use the group ACK through estimation based on TSPEC parameters which are already defined.

Deciding Group ACK Policy and Re-Ordering Buffer Size

The SME 703 on the non-AP QSTA (stream receiving station) 602 determines a group ACK policy (step 112). Whether to use an immediate group ACK policy or a delayed group ACK policy is determined according to how the receiving station 602 is implemented. Here, we suppose that the SME 703 has somehow obtained in advance information as to which group ACK policy will be used.

The SME 703 on the non-AP QSTA (stream receiving station) 602 determines a re-ordering buffer size (step 112). The SME 703 does so based on the information on the non-AP QSTA 602 the SME 703 collected in advance and the TSPEC defined in advance. For example, the SME 703 may estimate a maximum number of MSDUs that can be buffered from the capacity of the receive buffer expressed in bytes and the maximum MSDU size defined in the TSPEC (a maximum number of MSDUs expressed in bytes that can be transmitted in the stream); the maximum number of MSDUs can be used as the re-ordering buffer size.

Instead of the SME 703, the application 702 may determine the group ACK policy and the re-ordering buffer size which will be passed to the SME 703.

MLME-ADDGA.request

The SME 703 on the non-AP QSTA (stream receiving station) 602 issues an MLME-ADDGA.request (step 113). The conventional MLME-ADDGA.request is allowed to originate only from the stream transmitting station. The MLME-ADDGA.request does not include the group ACK policy or the re-ordering buffer size as parameters. On the other hand, the MLME-ADDGA.request of the present embodiment includes the group ACK policy and the re-ordering buffer size as parameters so that the stream receiving station 602 can also issue an MLME-ADDGA.request. The MAC 705 learns the group ACK policy and the re-ordering buffer size from the MLME-ADDGA.request. The MLME-ADDGA.request includes a TID.

Transmission of ADDGA Request Frame

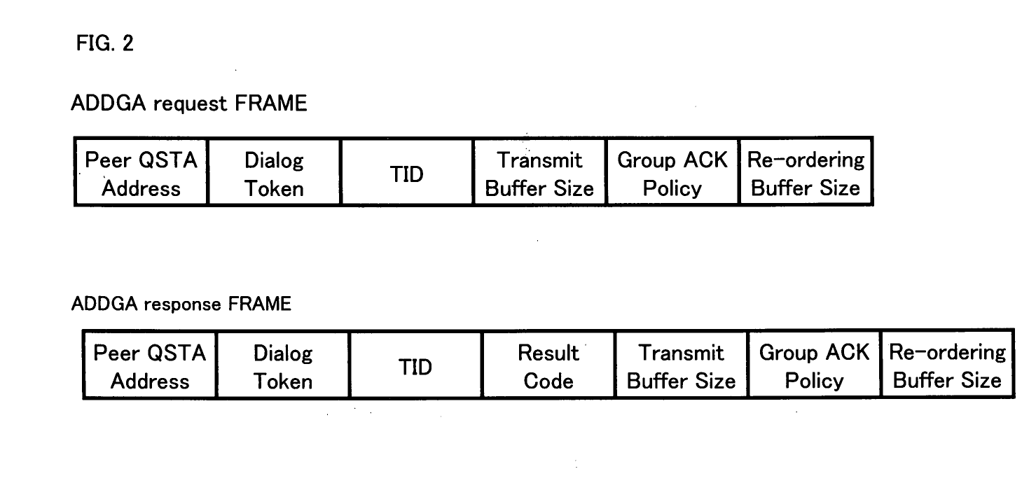

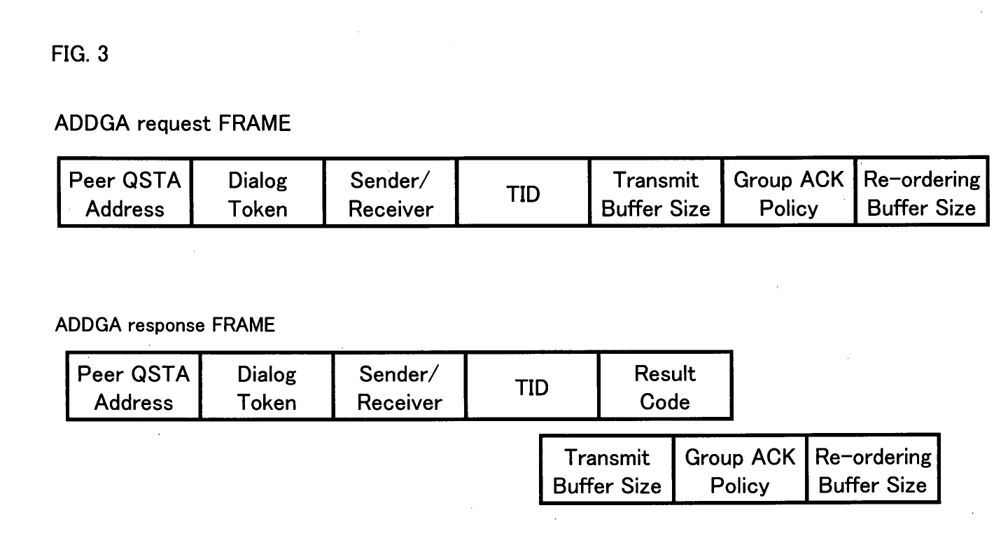

The MAC 705 on the non-AP QSTA (stream receiving station) 602 generates an ADDGA request frame which includes the group ACK policy, re-ordering buffer size, and other information passed from the SME 703. The MAC 705 then transmits the ADDGA request frame to the HC (stream transmitting station) 601 (step 114). The conventional ADDGA request frame is allowed to originate only from the stream transmitting station. The ADDGA request frame has no fields for the group ACK policy or the re-ordering buffer size. On the other hand, the ADDGA request frame in the present embodiment has fields for the group ACK policy and the re-ordering buffer size so that the stream receiving station can also transmit an ADDGA request frame. Examples of the field structure of such an ADDGA request frame are shown in FIGS. 2, 3 which will be detailed later.

MLME-ADDGA.indication

The MAC 805 on the HC (stream transmitting station) 601 analyzes the incoming ADDGA request frame and issues an MLME-ADDGA.indication (step 115). In conventional technology, the MLME-ADDGA.indication does not include the group ACK policy and the re-ordering buffer size as parameters. This is similarly to the MLME-ADDGA.request. On the other hand, the MLME-ADDGA.indication of the present embodiment includes the group ACK policy and the re-ordering buffer size as parameters. From the MLME-ADDGA.indication, the SME 803 on the HC 601 learns the group ACK policy and the re-ordering buffer size as well as the TID.

Determining Use of Group ACK

The SME 803 on the HC (stream transmitting station) 601 determines whether to use group ACK from the information pass in the MLME-ADDGA.indication (step 116). For example, if the HC 601 does not incorporate a group ACK mechanism, group ACK may not be used. From a result of the determination, the result code of an MLME-ADDGA.response is determined. The conventional result code is transmitted from the stream receiving station to the stream transmitting station. The result code of the present embodiment is transmitted from the stream transmitting station 601 to the stream receiving station 602. Current standard specifications can fall short of providing enough values to indicate a result. New values may be added to prevent this from happening. If the SME 803 determines to use group ACK, the SME 803 records the group ACK policy, re-ordering buffer size, etc. for use in an actual transmission of a group ACK.

Determining Transmit Buffer Size

The SME 803 on the HC (stream transmitting station) 601 determines the transmit buffer size (step 117). The SME 803 does so based on the information on the HC 601 the SME 803 collected in advance and the TSPEC defined in advance. For example, the SME 803 may estimate a maximum number of MSDUs that can be buffered from the capacity of the transmit buffer expressed in bytes and the maximum MSDU size defined in the TSPEC; the maximum number of MSDUs can be used as the transmit buffer size. The transmit buffer size may be adjusted according to the information transmitted in the ADDGA request frame from the stream receiving station 602.

MLME-ADDGA.response

The SME 803 on the HC (stream transmitting station) 601 issues an MLME-ADDGA.response (step 118). The conventional MLME-ADDGA.response is allowed to originate only from the stream receiving station. The MLME-ADDGA.response does not include the transmit buffer size as a parameter. On the other hand, the MLME-ADDGA.response of the present embodiment includes the transmit buffer size as a parameter so that the stream transmitting station can also transmit an MLME-ADDGA.response. The MAC 805 learns the result code, the transmit buffer size, etc. as the parameters of the MLME-ADDGA.response.

Transmission of ADDGA Response Frame

The MAC 805 on the HC (stream transmitting station) 601 generates an ADDGA response frame which includes the result code, transmit buffer size, and other information passed from the SME 803. The generated ADDGA response frame is then transmitted to the non-AP QSTA (stream receiving station) 602 (step 119). The conventional ADDGA response frame is allowed to originate only from the stream receiving station. The ADDGA response frame has no fields for the transmit buffer size. On the other hand, the ADDGA response frame of the present embodiment includes a field for the transmit buffer size so that the stream transmitting station 601 can also transmit an ADDGA response frame. Examples of the field structure of such an ADDGA request frame are shown in FIGS. 2, 3 which will be detailed later.

MLME-ADDGA.confirm

The MAC 705 on the non-AP QSTA (stream receiving station) 602 analyzes the incoming ADDGA response frame and sends an MLME-ADDGA.confirm (step 120). In conventional technology, the MLME-ADDGA.confirm does not include the transmit buffer size as a parameter. This is similar to the MLME-ADDGA.response. On the other hand, the MLME-ADDGA.confirm of the present embodiment includes the transmit buffer size as a parameter. From the MLME-ADDGA.confirm, the SME 703 on the non-AP QSTA 602 learns the transmit buffer size as well as the TID.

Prepare-for-Communication Response

The SME 703 on the non-AP QSTA (stream receiving station) 602 sends a prepare-for-communication response to the application (step 121). The prepare-for-communication response may include a result code passed from the MAC 705. Information may be modified based on the result code and passed to the application. The SME 703 may possibly indicate only whether group ACK is to be used for this stream, for example. Alternatively, the SME 703 may send the prepare-for-communication response only if the result code is a value indicating a success; if the result code is a value indicating a failure, the SME 703 may not send the prepare-for-communication response. When this is the case, the application 702 may determine that the prepare-for-communication request has failed if the application 702 does not receive a prepare-for-communication response within a predetermined time after the prepare-for-communication request.

If the ADDGA is determined to have failed, the HC (stream transmitting station) 601 transmits QoS data packets for the stream without using group ACK and assuming the use of normal ACK or no use of ACK at all. When this is the case, the non-AP QSTA (stream receiving station) 602 determines whether normal ACK is requested from the information contained in the packets and makes a proper response. Further, a prepare-for-communication request may be made again for the same stream, but at different transmission settings when the ADDGA has failed. For example, a prepare-for-communication request may be made again with a different group ACK policy and re-ordering buffer size. It is also possible to inform the user that the ADDGA has failed and stands by awaiting a next command from the user.

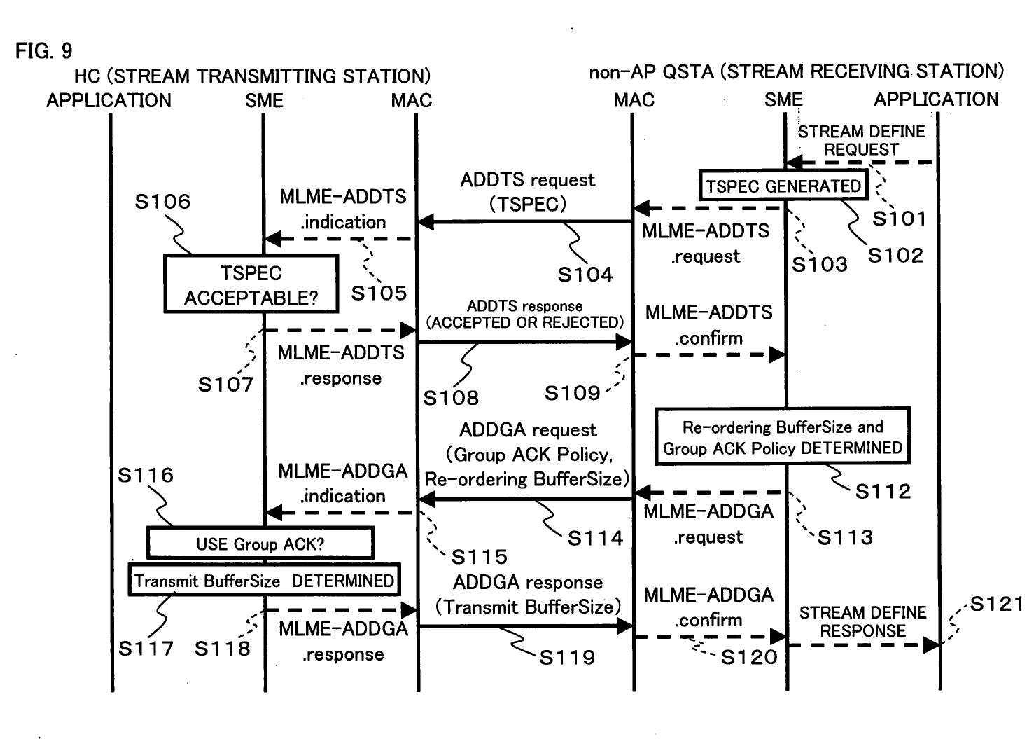

Upon receiving the MLME-ADDTS.confirm, the SME on the non-AP QSTA may issue the MLME-ADDGA.request on its own without notifying the application. This is illustrated in FIG. 9. When this is actually the case, the SME may issue the stream define response after receiving the. MLME-ADDGA.confirm; the application may not issue the prepare-for-communication request when it receives the stream define end notification. The stream define response may include results of the ADDTS and ADDGA so that the application can learn the results.

If the result code of the MLME-ADDTS.confirm indicates a fail, the stream define response may be issued with the MLME-ADDGA.request being omitted. The stream define response may include this failure of the ADDTS so that the application can learn the failed ADDTS.

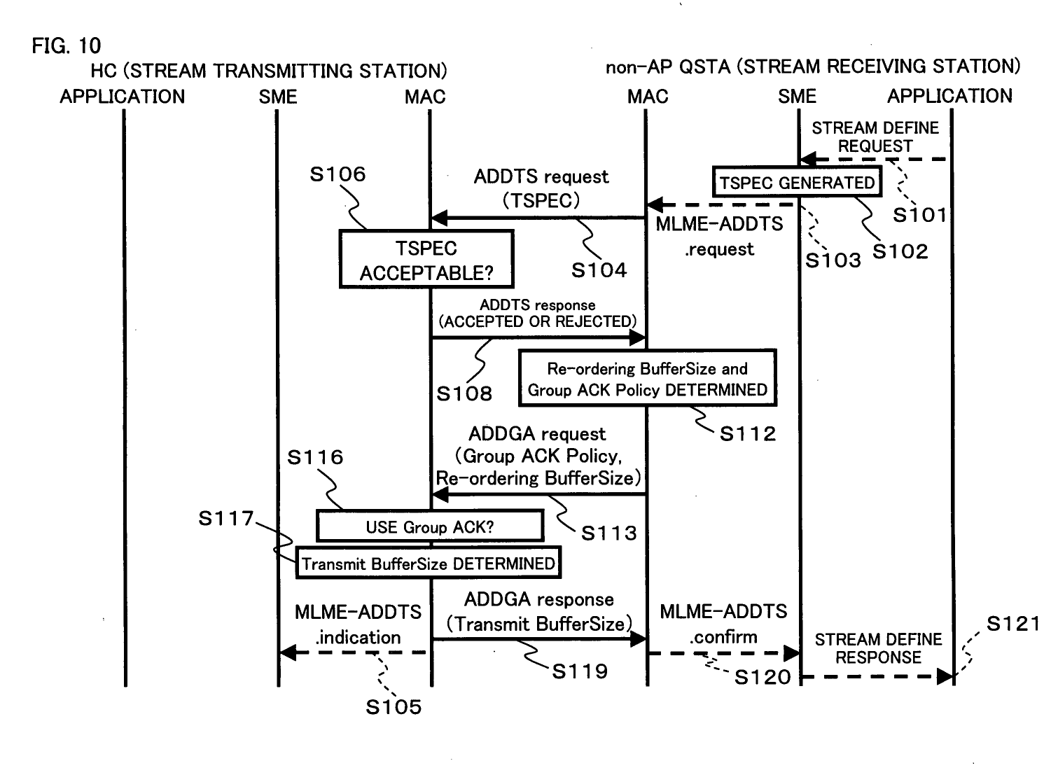

The MAC on the non-AP QSTA may transmit an ADDGA request frame on its own in response to a receipt of the ADDTS response frame. This is illustrated in FIG. 10. When this is actually the case, the MAC may send an MLME-ADDTS.confirm after receiving the ADDGA response frame and hence verifying that both the ADDTS and ADDGA have completed. If the MAC receives no ADDGA response frame within a predetermined time after the transmission of the ADDGA request frame, the MAC may notify the SME that the process has failed through an MLME-ADDTS.confirm.

In this case, the MAC decides the re-ordering buffer size and the group ACK policy included in the ADDGA request frame. The MAC either collects in advance or obtains from the SME information needed to make the decision.

Steps in FIGS. 9, 10, if identical in content to those in FIG. 1, bear the same numbers as in FIG. 1. The numbering of the steps in FIGS. 9, 10 does not match the sequence in which the steps are carried out. Some steps are identical in content, but carried out at different layers; these steps still have the same number.

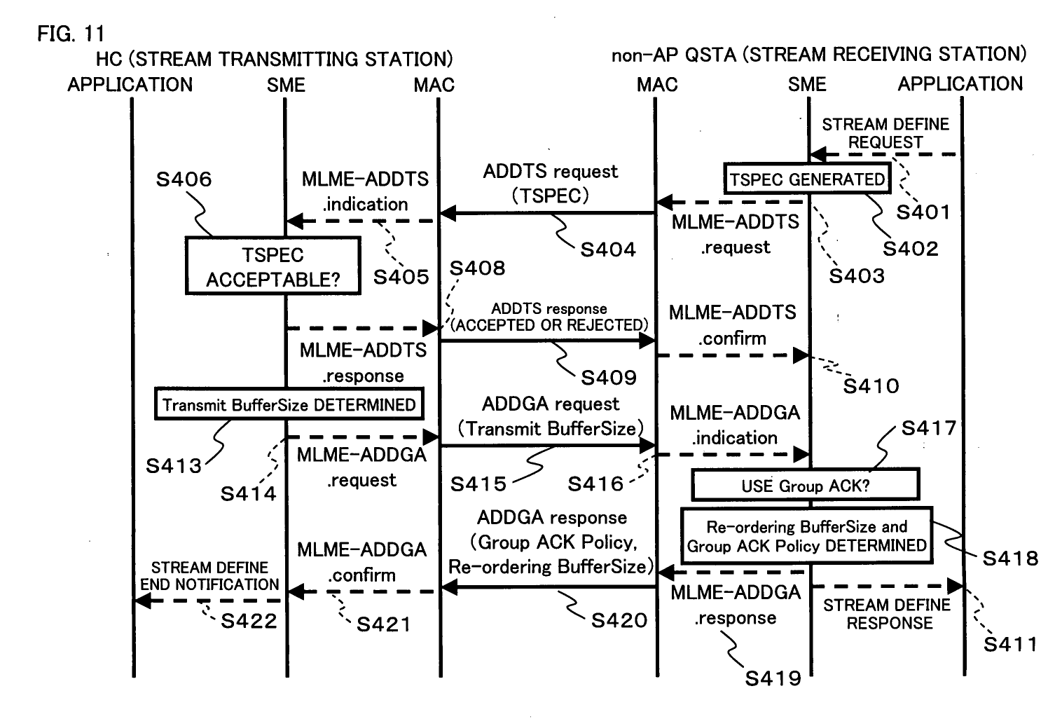

The above remarks are also applicable to FIGS. 11, 12, and 13 in relation to embodiments 2 and 3.

Decision in Relation to Content of ADDGA Request Frame and ADDGA Response Frame

Now, FIGS. 2 and 3 will be described in detail. In the present embodiment, the ADDGA request frame and the ADDGA response frame include fields that are actually not necessary when transmitted. When the ADDGA request frame is transmitted from the stream receiving station for example, the transmit buffer size is not needed, but is still included in the ADDGA request frame. This leads to a need for the receiving side to discriminate between necessary and unnecessary fields. The discrimination can be done by one of the three methods below:
Method 1. The transmitting station of the ADDGA request frame or the ADDGA response frame assigns a special value to the fields that should be ignored in that frame. The frame receiving station regards the fields with special values as being invalid.

The method can be implemented on the FIG. 2 frame structure: the frame transmitting station assigns a 0 to all the bits in the fields that should be ignored, and the frame receiving station disregards those fields with 0s in all the bits, for example.
Method 2. The receiving station of the ADDGA request frame or the ADDGA response frame determines useless fields from information as to whether that station is a stream transmitting station or a stream receiving station.

The method can be implemented, for example, by the stream transmitting station when it has received an ADDGA request frame having the same frame structure as that shown in FIG. 2, in order to determine that the transmit buffer size field is invalid.
Method 3. The ADDGA request frame or the ADDGA response frame is provided with a field indicating whether the source of that frame is a stream transmitting station or a stream receiving station. The frame transmitting station assigns a proper value to the field. The frame receiving station determines useless fields from the assigned value.

The method can be implemented by providing the ADDGA request frame and the ADDGA response frame with a sender/receiver field as shown in FIG. 3, for example. If the stream receiving station transmits the frame, it assigns a value indicating a receiver to the sender/receiver field; if the stream transmitting station transmits the frame, it assigns a value indicating a sender to the sender/receiver field. The frame receiver regards the group ACK policy field and the re-ordering buffer size field as being invalid if the sender/receiver field contains a value indicating a sender. If the sender/receiver field contains a value indicating a receiver, the frame receiver regards the transmit buffer size field as being invalid. Alternatively, the ADDGA request frame or the ADDGA response frame may be provided with a field indicating whether the address, not the source, of that frame is a stream transmitting station or a stream receiving station. This alternative achieves similar results.

Associating Sender/Receiver Fields and Streams

In the IEEE 802.11e, the MAC uses the TID for stream identification. In some cases, the same TID is used when two stations are communicating a stream with each other in a direct link stream. In such a case, the conventional ADDGA request frame and ADDGA response frame include only the TID, failing to give sufficient information to correctly associate the frame with its corresponding stream.

Suppose, as an example, that the STA1 defines a stream with “3” in the TID so that the STA2 can identify the stream and also that the. STA2 likewise defines a stream with “3” in the TID so that the STA1 can identify the stream. If the STA1 transmits the STA2 an ADDGA request frame with the TID field set to 3, the destination STA2 will not know whether it should set up a group ACK for the stream it is receiving or for the stream it is transmitting.

However, in the present invention, the ADDGA request frame and the ADDGA response frame are provided with a sender/receiver field. If the frame transmitting station transmits, in the sender/receiver field, information as to whether it is the stream transmitting station or the stream receiving station, the frame receiving station can correctly identify a stream based on the information and TID.

In the present embodiment, a frame is provided with separate fields for the transmit buffer size and the re-ordering buffer size. The two fields may be merged into a single field. From the value in the sender/receiver field, the frame receiving station can determine whether the field's content indicates the transmit buffer size or the re-ordering buffer size.

How to Determine Group ACK Policy

The group ACK policy is a field specifying a group ACK type. The stream transmitting station and the stream receiving station need to agree upon which type to use. One of methods is to determine in advance which of the stream transmitting station or the stream receiving station is to be given priority.

In the present invention, both the stream transmitting station and the stream receiving station could transmit an ADDGA request frame. Each station should know whether it is the stream transmitting station or the stream receiving station when the station decides on the group ACK policy upon receipt of an ADDGA request frame. In the present invention, the sender/receiver field indicates whether the frame originated from the stream transmitting station or the stream receiving station.

Suppose, as an example, that priority is given to the stream receiving station. If the sender/receiver field in a received ADDGA request frame indicates Receiver, and the ADDGA request frame specifies a group ACK policy the station supports, the station always includes the same group ACK policy value in the ADDGA response frame as that in the ADDGA request frame. If the ADDGA request frame specifies a group ACK policy the station does not support, the station includes information indicating the lack of support in the ADDGA response frame.

If the sender/receiver field in a received ADDGA request frame indicates Sender, the group ACK policy in the ADDGA response frame is not necessarily the same as that in the ADDGA request frame. The station can specify a group ACK policy it wants to use.

The other station (which receives the ADDGA response) unconditionally follows the group ACK policy specified in the ADDGA response frame if the station supports the specified group ACK policy, because the sender/receiver field in the frame indicates Receiver. If the station does not support the specified group ACK policy, the station regards the ADDGA as having failed and communicates that to the application. The ADDGA request may be retransmitted with different parameters.

The above mechanism gives priority to the stream receiving station whether the ADDGA request frame originates from the stream transmitting station or the stream receiving station.

In a conventional mechanism, a station, upon receipt of an ADDGA request frame, responds by sending an ADDGA response frame including only information as to whether the station accepts or rejects the group ACK policy specified in the ADDGA request. To decide on a group ACK policy, In the worst case scenario, the ADDGA request frame and the ADDGA response frame must be exchanged the same number of times as the number of group ACK policy types. However, according to the decision-making method of the present invention on group ACK policy, the ADDGA request frame and the ADDGA response frame need be exchanged only once to decide on the group ACK policy, on the assumption that both stations support all group ACK policy types.

Currently, there are only two types of group ACK policy, and advantages brought by the method may not be much appreciated. The method however could be lot more effective in the future when there are more types of group ACK policy or in determining more than the two parameters. If there are five types of group ACK policy, for example, conventional methods need to exchange the ADDGA request frame and the ADDGA response frame five times in the worst case scenario. According to the method of the present invention, the group ACK policy can be determined by a single exchange of the ADDGA request frame and the ADDGA response frame.

If the group ACK policy specified by the station with the decision-making priority is not supported by the other station involved in communications, a single exchange is not sufficient to make a decision. Still, the station with the decision-making priority can learn that the desired group ACK policy cannot be used. The station can thus proceed to another step: for example, requesting another station to perform ADDGA.

The present embodiment has so far demonstrated an example where the ADDTS is implemented before the ADDGA. The embodiment is however applicable also to the ADDGA being implemented before the ADDTS. When this is actually the case, the SME on the non-AP QSTA sends a prepare-for-communication response to the application on the non-AP QSTA which issues a stream define request.

The aforementioned process is not limited to group ACK policy. The process is applicable to another parameter upon which the stream transmitting station and the stream receiving station need to agree.

The criterion by which priority is determined in making the agreement may be altered based on a parameter other than the sender/receiver field. For example, if priority is to be given to the HC, a field indicating either the HC or the non-AP QSTA may be provided in place of the sender/receiver field.

The frame transmitting station may communicate information corresponding to the sender/receiver field in advance with the receiving station before the ADDGA request frame is transmitted. Priority may be determined based on the information, and group ACK policy determined.

The MAC (705, 805) in the present embodiment corresponds to the compare means recited in claims which compares priority.

### Embodiment 2

The second embodiment of the present invention is now described. The embodiment demonstrates a method for the application on the stream transmitting station to know a timing when the ADDTS ends. This is achieved by the stream transmitting station requesting the MAC to return a response to the ADDTS and at the same time sending a response to the ADDTS also to the application. Accordingly, that application which initiates the ADDGA can know a timing when the ADDTS completes. The ADDGA can be implemented after checking that the ADDTS has completed.

Briefly, the overall operation flow goes like this: The application 702 on the stream receiving station 602 issues a stream define request. The stream transmitting station 601 returns a response to the request and at the same time sends a stream define end notification also to the application 802. Following this, the application 802 transmits a prepare request, and the ADDGA is initiated by the stream transmitting station 601.

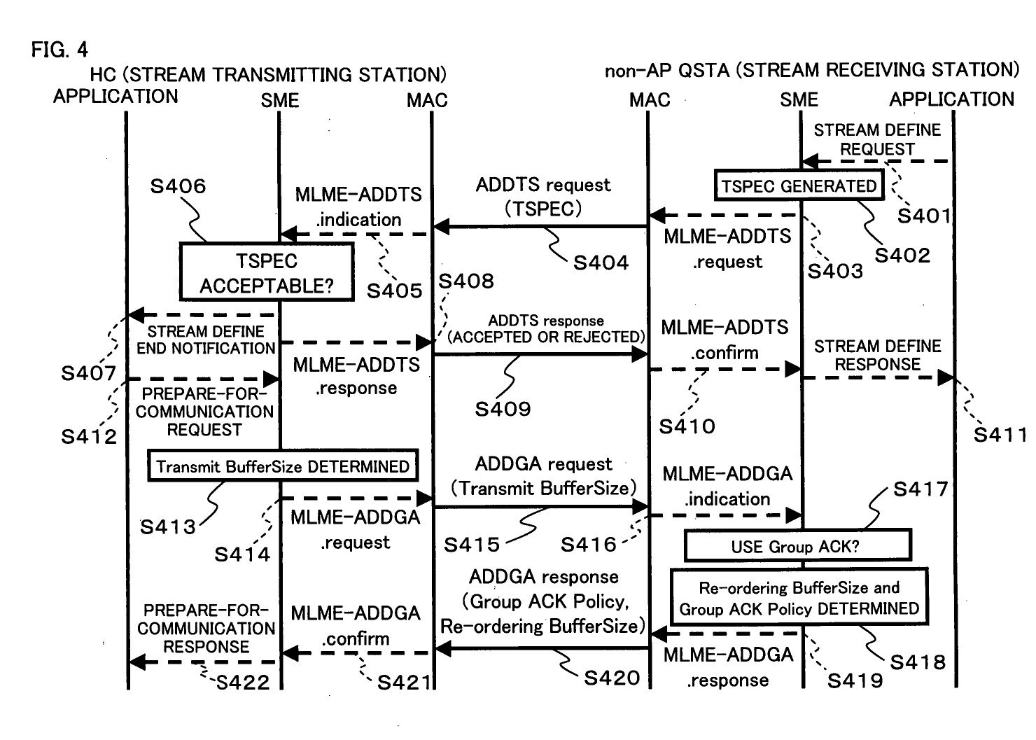

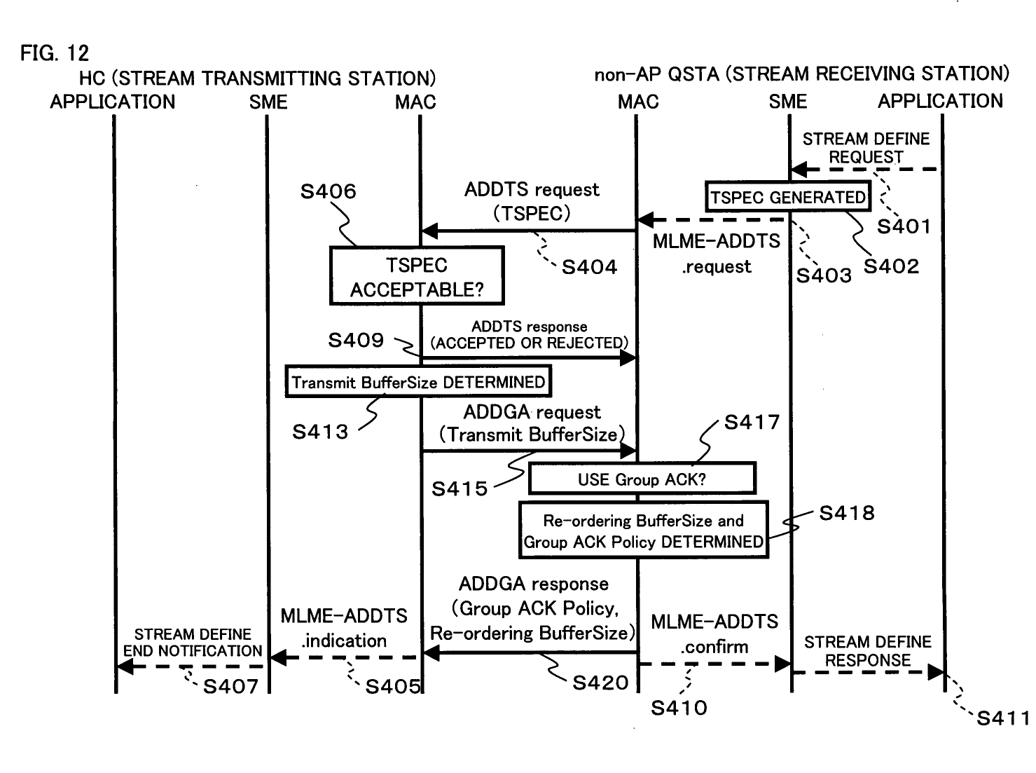

A bandwidth management section 811 at the SME 803 in FIGS. 4 and 11 and the MAC 805 in FIG. 12 in the present embodiment correspond to determine means recited in claims.

Here, the process is now described in more detail in reference to FIGS. 4, 6, 7, and 8.

Stream Define Request

The application 702 on the non-AP QSTA (stream receiving station) 602 sends a stream define request to the SME 703 (step 401). The request includes the encoding format, bit rate, and other information on the stream to be transmitted.

ADDTS

Thereafter, the non-AP QSTA (stream receiving station) 602 and the HC 601 perform ADDTS (steps 402 to 406, 408 to 410). The process is identical to that used in conventional technology. No detail is given here. We described a direct link stream example in relation to conventional technology. The stream transmitting station therefore performed ADDTS. This is different from the present embodiment which will deal with a downlink stream where the stream receiving station 602 performs the ADDTS.

The embodiment has its features from the decision as to whether to accept or reject TSPEC (step 406) up to the transmission of an MLME-ADDTS.response from the SME 803 on the HC 601 (step 408). The description will focus on this part of the process.

Stream Define End Notification

Upon receipt of a TSPEC from the MAC 705, the bandwidth management section 811 of the SME 803 on the HC 601 determines whether the TSPEC is acceptable (step 406). As the determination as to whether the TSPEC is acceptable ends, the bandwidth management section 811 sends a stream define end notification to the application 802 which will issue a prepare-for-communication request (step 407).

The stream define end notification includes the MAC address of the stream receiving station 601 and the TID as information by which a stream is identified at the application 802. The MAC address and TID may be replaced with other information so long as the application 802 can identify the stream.

The stream define end notification may include a result code which will be communicated to the MAC 805 through an MLME-ADDTS.response (step 408). The stream define end notification may include other information obtained by converting back the result code. For example, only the information as to whether the HC 601 has accepted the TSPEC may be included.

If the application 802 on the stream transmitting station is adapted to issue a prepare-for-communication request only when the stream define end notification indicates a success, ADDGA is implemented only when ADDTS is successful. In addition, the stream define response may be sent only if the result code has a value indicating a success; no stream define response needs be sent if the result code has a value indicating a failure. When this is actually the case, if the application 802 is adapted to issue the prepare-for-communication request only upon reception of the stream define end notification, ADDGA is implemented only when ADDTS is successful.

The stream define end notification may not be sent immediately after the determination as to whether the TSPEC is acceptable (step 407). The stream define end notification may be sent, for example, after waiting for an estimated period of time for the ADDTS to completely come to an end (step 410). Either the stream define end notification (step 407) or the MLME-ADDTS.response (step 408) may be transmitted first.

Thereafter, the SME 803 sends an MLME-ADDTS.response to the MAC 805 (step 408). The action will be communicated to the stream transmitting station 601. Description of further details is omitted in the present embodiment.

Prepare-for-Communication Request

After receiving the stream define end notification, the application 802 on the HC 601 analyzes its content to obtain the MAC address and TID. The application 802 then issues a prepare-for-communication request to the SME 803 (step 412).

ADDGA Process

Steps following the SME 803 on the HC 601 receiving the prepare-for-communication request (step 413 to step 421) are basically identical to the corresponding steps described in relation to conventional technology. The ADDGA request frame and the ADDGA response frame are transmitted by the same method as in conventional technology. Not both of the ADDGA request and the ADDGA response need to include both the information communicated from the stream transmitting station to the stream receiving station and the information communicated from the stream receiving station to the stream transmitting station, as in FIGS. 2, 3 of embodiment 1. The formats of the conventional ADDGA request frame and ADDGA response frame can be used.

Prepare-for-Communication Response

As the ADDGA ends, the SME 803 sends a prepare-for-communication response to the application 802 on the HC 601 (step 422). Thus, the application 802 on the HC 601 can know that both the ADDTS and the ADDGA have completed.

The present embodiment has so far demonstrated an example where the ADDTS is implemented before the ADDGA. The embodiment is however applicable also to the ADDGA being implemented before the ADDTS. When this is actually the case, the SME on the non-AP QSTA issues an MLME-ADDTS.request on its own after issuing an MLME-ADDGA.response.

In addition, as shown in FIG. 11, the HC SME may issue an MLME-ADDGA.request on its own upon receipt of an MLME-ADDTS.indication. When this is actually the case, the SME may issue the stream define end notification after receiving the MLME-ADDGA.confirm; the application does not need to issue a prepare-for-communication request upon receipt of the stream define end notification. The stream define end notification, which is communicated to the application, may include results of the ADDTS and ADDGA.

If the TSPEC is not acceptable, the stream define end notification may be issued with the MLME-ADDGA.request being omitted. The stream define end notification may include an indication of the failure of the ADDTS when sent to the application.

The SME on the non-AP QSTA does not issue a stream define response when it has received an MLME-ADDTS.confirm. The SME issues a stream define response after the SME has received an MLME-ADDGA.indication. The SME may include results of the ADDTS and ADDGA in the stream define response so that the application can know the results.

The HC SME may issue the MLME-ADDGA.request upon transmission of an MLME-ADDTS.response, not upon receipt of an MLME-ADDTS.indication.

Further, as shown in FIG. 12, the MAC may transmit an ADDGA request frame on its own upon receipt of an ADDTS request frame, in which case the SME issues no stream define end notification or MLME-ADDGA.request. The MLME-ADDGA.confirm can be issued, for example, (1) immediately after the HC has received an ADDGA response frame sent back from the non-AP QSTA, (2) in the absence of an incoming ADDGA response frame for a predetermined period after transmission of an ADDGA request frame, or (3) immediately after transmission of an ADDGA request frame.

When this is actually the case, the MAC determines the transmit buffer size included the ADDGA request frame. Information needed to do so can be collected in advance or obtained from the SME.

The HC SME may transmit the ADDGA request frame no upon receipt of the ADDTS request frame, but upon transmission of the ADDGA response frame. If the MAC on the non-AP QSTA has correctly received the ADDTS response frame, the MAC on the non-AP QSTA returns an ACK to the HC MAC. Upon receipt of this ACK, the HC SME may transmit the ADDGA request frame.

### Embodiment 3

The third embodiment of the present invention is now described. The embodiment demonstrates a method for an application on a stream receiving station to transmit a stream define end frame to an application on a stream transmitting station after receiving a stream define response. The method enables an ADDGA-initiating application to know when ADDTS completes. The application can implement the ADDGA after checking completion of the ADDTS.

Briefly, the overall operation flow goes like this: the application 702 on the stream receiving station 602 issues a stream define request. The ADDTS completes. The application 702 on the stream receiving station 602 receives a stream define response and transmits a stream define end frame to the application 802 on the stream transmitting station 601. The application 802 on the stream receiving station 601 issues a prepare-for-communication request. The ADDGA is implemented.

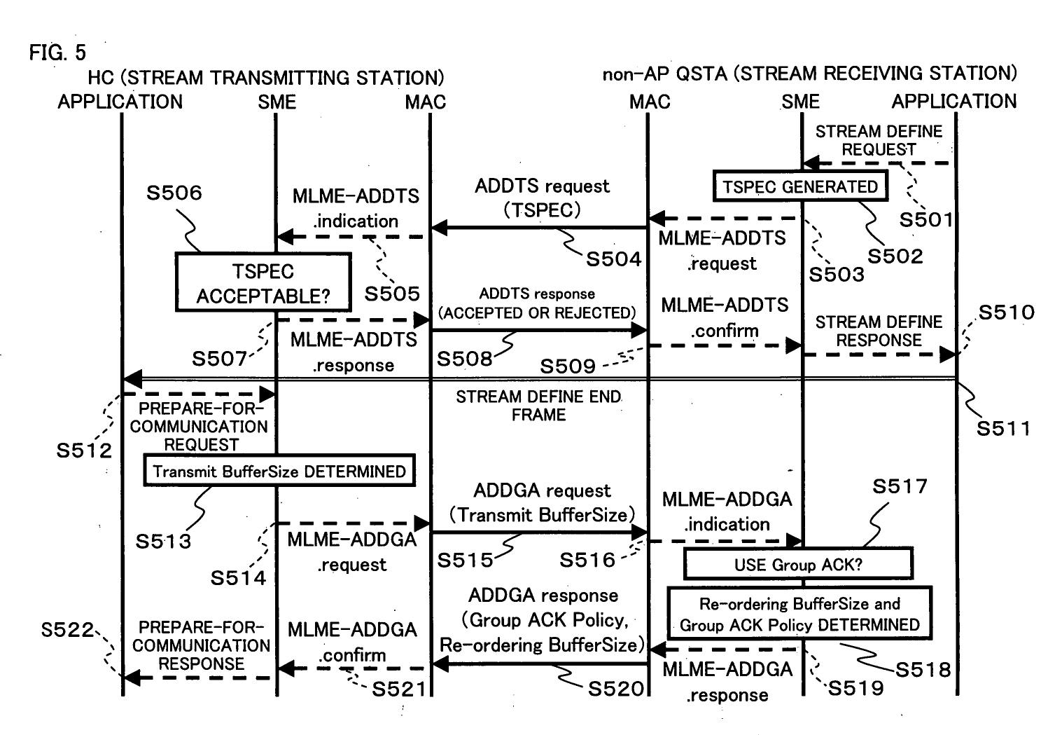

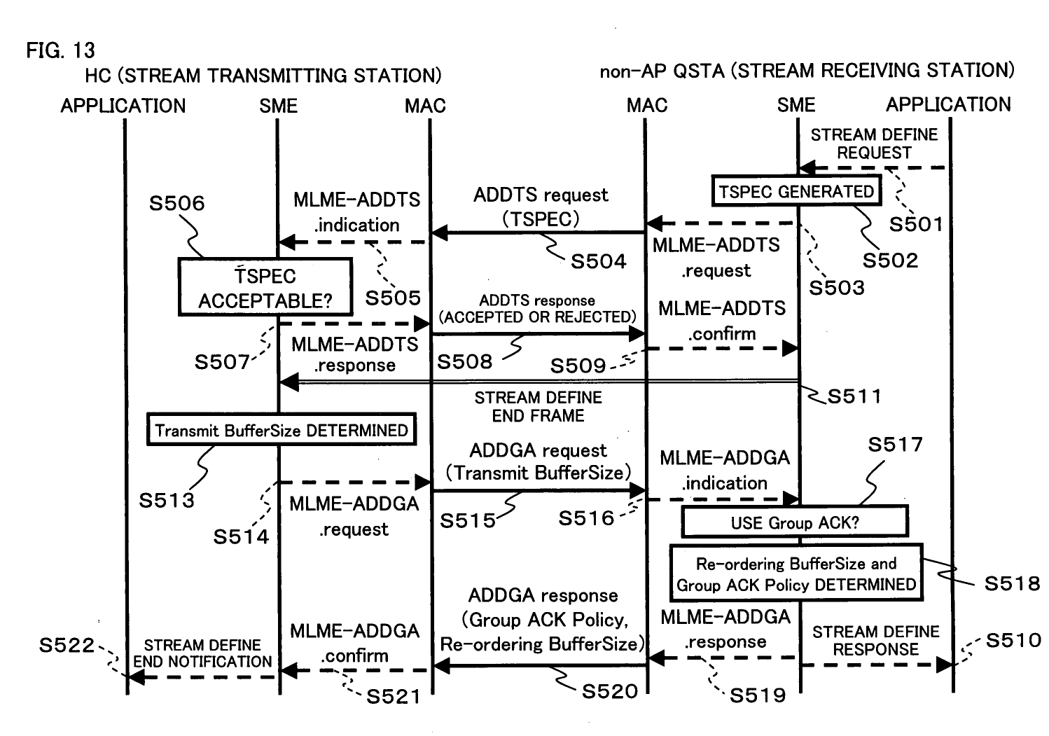

The application 702 in FIG. 5 and the SME 703 in FIG. 13 in the present embodiment correspond to the determine means recited in claims.

The SME 703, MLME 704, MAC 705, and wireless section 710 correspond to the notify means recited in claims.

Here, we will describe details of operation in reference to FIGS. 5, 6, 7, and 8.

Stream Define Request

The application 702 on the non-AP QSTA (stream receiving station) 602 sends a stream define request to the SME 703 (step 501). The stream define request includes the encoding format, bit rate, and other information on the stream to be transmitted.

ADDTS

Thereafter, the non-AP QSTA (stream receiving station) 602 and the HC 601 perform ADDTS (step 502 to step 509). The process is identical to the one described in relation to conventional technology. Description of details is omitted. To explain conventional technology, a direct link stream was taken as an example; therefore, the stream transmitting station performed ADDTS. The present embodiment deals with a downlink stream and hence differs where it is the stream receiving station 602 that performs ADDTS. The present embodiment has its features in the process following the receipt of a stream define response (step 510) by the application 702 on the stream receiving station 601. The description will focus on this part of the process.

Stream Define Response

The SME 703 on the non-AP QSTA (stream receiving station) 601 sends a stream define response to the application 702 upon receipt of a MLME-ADDTS.confirm from the MAC (step 510). The stream define response includes a TID found in the TSPEC as information by which the application identifies a stream. The TID may be replaced with other information so long as the application can identify the stream.

Stream Define End Frame

The application 702 on the non-AP QSTA (stream receiving station) 602 transmits a stream define end frame to the application 802 on the HC (stream transmitting station) 601 (step 511). The frame includes the MAC address of the stream receiving station 601 and the TID of the stream as information by which the application 802 on the HC (stream transmitting station) 601 identifies the stream. The MAC address and the TID may be replaced with other information so long as the application 802 can identify the stream.

The stream define end frame is exchanged as a frame recognizable by the applications. This is not the only possibility; the frame may be, exchanged between other layers.

For example, when the frame is exchanged as a frame recognizable by the SMEs, the SME on the non-AP QSTA may transmit a stream define end frame to the HC SME on its own upon receipt of an MLME-ADDTS.confirm.

When this is actually the case, the SME may issue an MLME-ADDGA.request on its own upon receipt of a stream define end frame and send a stream define end notification upon receipt of an MLME-ADDGA.confirm with the HC application issuing no prepare-for-communication request. Further, the SME on the non-AP QSTA may issue a stream define response after issuing an MLME-ADDGA.response.

If the TSPEC is not acceptable, the stream define end notification may be issued with the MLME-ADDGA.request being omitted. The stream define end notification may include an indication of the failure of the ADDTS when sent to the application.

The SME on the non-AP QSTA may omit the stream define end frame and send a stream define response to the application if the MLME-ADDTS.confirm indicates that the ADDTS has failed. The stream define response may include an indication of the failure of the ADDTS when sent to the application.

Similarly to the stream define request and the prepare-for-communication response, the MAC may provide a service primitive to send a stream define end frame so that the application 702 can execute the service primitive and the SME 703 can generate the stream define end frame.

Similarly to the MLME-ADDTS.request and the MLME-ADDGA.request, the MAC may provide a service primitive transmitting a stream define end frame as a service primitive so that the SME can execute the service primitive and the MAC can generate the stream define end frame.

This signal may be transmitted over a different network from the one over which the stream, the ADDTS request/response, the ADDGA request/response, etc. are transmitted.

The stream define end notification may include the result code sent in the MLME-ADDTS.confirm (step 509). The stream define end frame may include other information obtained by converting back the result code. For example, only information as to whether the ADDTS has been successful may be included.

If the application 802 on the stream transmitting station 601 is adapted to issue a prepare-for-communication request only when the stream define end notification indicates a success, the ADDGA is performed only when the ADDTS has been successful.

The stream define response may be sent only when the result code has a value indicating a success. No stream define response may be sent when the result code has a value indicating a failure.

When this is actually the case, if the application 802 on the stream transmitting station 601 is adapted to issue a prepare-for-communication request only when the application 802 has received a stream define end frame, the ADDGA is performed only when the ADDTS has been successful.

Prepare-for-Communication Request

Upon receipt of the stream define end notification, the application 802 on the HC (stream transmitting station) 601 analyzes its content to obtain the included MAC address and TID. The application 802 then issues a prepare-for-communication request for the stream identified from this information to the SME 803 (step 512).

ADDGA

Steps following the SME 803 on the HC 601 receiving the prepare-for-communication request (step 513 to step 521) are basically identical to the corresponding steps described in relation to conventional technology. The ADDGA request frame and the ADDGA response frame are transmitted by the same method as in conventional technology. Not both of the ADDGA request and the ADDGA response need to include both the information communicated from the stream transmitting station to the stream receiving station and the information communicated from the stream receiving station to the stream transmitting station, as in FIGS. 2, 3 of embodiment 1. The formats of the conventional ADDGA request frame and ADDGA response frame can be used.

Prepare-for-Communication Response

As the ADDGA ends, a prepare-for-communication response is sent to the application 802 on the HC 601 (step 522). Thus, the application 802 on the HC 601 can know that both the ADDTS and the ADDGA have completed.

The present embodiment has so far demonstrated an example where the ADDTS is implemented before the ADDGA. The embodiment is however applicable also to the ADDGA being implemented before the ADDTS. When this is actually the case, the HC transmits a frame indicating the completion of the ADDGA (equivalent to the stream define end frame) to the non-AP QSTA when the HC has completed the ADDGA.

### Supplement to Embodiments

The embodiments of the present invention have so far described methods whereby the same station triggers both the ADDTS and the ADDGA in IEEE 802.11e. These are mere examples. The present invention is generally applicable for a single station to initiate multiple processes. There are no limits at all on communications protocol and medium.

An application example of the present invention is given in the following. The current draft of IEEE 802.11e specifies Direct Link Protocol (DLP) for a direct link stream transmission.

The IEEE 802.11e allows the non-AP QSTA to switch to power save mode. In this mode, the non-AP QSTA cannot receive packets from other stations.

Here, the AP can switch the non-AP QSTA from power save mode to ordinary mode. The non-AP QSTA cannot make such an instruction to another non-AP QSTA.

Therefore, in a direct link stream, the non-AP QSTA checks by DLP whether the data destination has switched to power save mode before initiating communications. In this DLP, multiple packets are communicated between non-AP QSTAs as in the ADDTS and ADDGA.

Here, for example, if the ADDGA is done before the DLP, the ADDGA fails when the destination has switched to power save mode. The ADDGA should therefore be initiated after checking completion of the DLP. Therefore, the present invention is applicable to this case too.

As described in the embodiments above, an objective of the present invention is to enable either one of the stream transmitting station and the stream receiving station to trigger bandwidth allocation and ACK transmission method setup on a communications network involving multiple communications stations and a central control station when a downlink stream transmission is done from the central control station to the communications station.

The embodiments have fulfilled the objective by the following three communications managing methods.

In embodiment 1, the stream receiving station is enabled to trigger ACK setup. ACK type information is included in an ACK setup request frame.

In embodiment 2, the central control station transmits an ACK setup request to the stream receiving station as triggered by a bandwidth allocation request transmitted from the stream receiving station.

In embodiment 3, a new frame is defined which communicates a completion of a bandwidth allocation request or an ACK setup request, by one of communications stations, issued from another station.

Each block in the non-AP QSTA and the HC in embodiments 1 to 3, especially the applications (702, 802), SMEs (703, 803), MLMEs (704, 804), and MACs (705, 805), may be constructed from hardware logic. Alternatively, the blocks may be realized by software executed by a CPU.

Specifically, the non-AP QSTA and the HC each includes: a CPU (central processing unit) for executing instructions of a control program realizing the functions; a ROM (read only memory) storing the program; a RAM (random access memory) for developing the program; and a memory device (storage medium) such as a memory storing the program and various kinds of data. The objective of the present invention can be achieved as follows: A storage medium containing computer program code of a control program (execute form program, intermediate code program, source program) for the non-AP QSTA and the HC which is software realizing the aforementioned functions in a computer-readable manner is provided to the non-AP QSTA and the HC. The computer (or CPU or MPU) reads and carries out the program code contained in the storage medium, thereby achieving the objective.

The storage medium may be, for example, a tape, such as a magnetic tape or a cassette tape; a magnetic disc, such as a floppy (registered trademark) disc or a hard disk, or an optical disc, such as a CD-ROM/MO/MD/DVD/CD-R; a card, such as an IC card (memory card) or an optical card; or a semiconductor memory, such as mask ROM/EPROM/EEPROM/flash ROM.

The non-AP QSTA and the HC may be constructed connectable to a communications network, so that the program code can be downloaded from the communications network. The communications network is by no means limited in any particular manner and may be, for example, the Internet, an Intranet, an Extranet, a LAN, an ISDN, a VAN, a CATV communications network, a virtual private network, a telephone network, a mobile communications network, and a satellite communications network. In addition, the transfer medium which is part of the communications network is by no means limited in any particular manner and may be, for example, either: wired (e.g. IEEE 1394, USB, an electric power line transport, a cable TV line, a telephone line, and an ADSL line), infrared (IrDA and a remote controller), or wireless (the Bluetooth, a 802.11 wireless, HDR, a mobile phone network, a satellite channel, and terrestrial digital network). The present invention may be realized by a carrier wave or a series of data signals representing an embodiment of the code by electronic transmission.

A communications device in accordance with the present invention, as described in the foregoing, is part of a network system involving multiple communications devices and a communications network connecting the devices. The communications device includes transmit means for transmitting signals from the communications device to another communications device. The signals are transmitted first in respective communications establish processes performed between the communications device and the other communications device so as to establish data communications between the communications device and the other communications device.

According to the arrangement, the communications device sends the other communications device all signals that should be transmitted first in respective communications establish processes performed between the communications device and the other communications device so as to establish data communications between the communications device and the other communications device.

Therefore, the communications device becomes the source for all signals that should be transmitted first.

Therefore, the communications device can determine alone when to initiate/trigger the communications establish processes. Therefore, the processes required to establish data communications can be done efficiently.

Another communications device in accordance with the present invention, in the foregoing communications device, is such that: the other communications device is a central control device for managing a transmission right for the communications network; the data communications are a downlink stream communications from the other communications device to the communications device; and the transmit means transmits a request signal, as the signals, to the other communications device. The request signal indicates a request for an ACK information specify process related to group ACK to establish the downlink stream communications.

According to the arrangement, the communications device can send another communications device a request signal indicating a request for specification of ACK information related to group ACK so as to establish the downlink stream communications.

To enable downlink stream communications, the ACK information specify process and the bandwidth information specify process are needed between the communications device and the other communications device. Further, the bandwidth information specify process is initiated by transmitting a request signal from the communications device to the other communications device.

Therefore, with the arrangement, the communications device becomes the source for both the request signal indicating a request for specification of ACK information related to group ACK and the request signal used in the bandwidth information specify process.

Therefore, the communications device can determine alone when to initiate the ACK information specify process related to group ACK and when to initiate the bandwidth information specify process. Therefore, the processes required to establish downlink stream communications can be done efficiently.

Another communications device in accordance with the present invention, in the foregoing communications device, is such that the request signal also indicates information on a group ACK type desired by the communications device and information on a stream receive buffer size in the communications device.

Therefore, the request signal transmitted from the communications device to the other communications device (central control device) indicates information on an ACK transmission scheme type desired by the communications device and information on a stream receive buffer size in the communications device.

Therefore, the communications device can notify the central control device of information required to complete the ACK information specify process related to group ACK.

Another communications device in accordance with the present invention, as described in the foregoing, is part of a network system involving multiple communications devices and a communications network connecting the devices. The communications device includes receive means for receiving signals from another communications device. The signals are transmitted first in respective communications establish processes performed between the communications device and the other communications device so as to establish data communications between the communications device and the other communications device. The communications device further includes transmit means for transmitting, to the other communications device, response signals respectively to the signals which are transmitted first.

According to the arrangement, the communications device receives, from the other communications device, all signals that should be transmitted first in respective communications establish processes performed between the communications device and the other communications device so as to establish data communications between the communications device and the other communications device. Further, the communications device sends the other communications device a response signal to each signal that should be transmitted first.

Therefore, the communications device becomes the destination for all signals that should be transmitted first. In other words, the other communications device becomes the source for all signals that should be transmitted first. Further, the other communications device can determine the status of the communications establish processes from the incoming response signals.

Therefore, the other communications device can determine alone when to initiate/trigger the communications establish processes. Therefore, the processes required to establish data communications can be done efficiently.

Another communications device in accordance with the present invention, in the foregoing communications device, is such that: the communications, device is a device for managing a transmission right for the communications network; the data communications is a downlink stream communications from the communications device to the other communications device; and the receive means receives a request signal, as the signals, from the other communications device. The request signal indicates a request for an ACK information specify process related to group ACK to establish the downlink stream communications.

According to the arrangement, the communications device receives, from the other communications device, a request signal indicating a request for specification of ACK information related to group ACK so as to establish the downlink stream communications. Also, the communications device sends the other communications device a response signal to the request signal indicating a request for specification of ACK information related to group ACK.

Therefore, the communications device sends the other communications device a response signal to the request signal indicating a request for specification of ACK information. Therefore, the ACK information specify process can be done when the other communications device is the source for the request signal indicating a request for specification of ACK information.

To enable downlink stream communications, the ACK information specify process related to group ACK and the bandwidth information specify process are needed between the communications device and the other communications device. Further, the bandwidth information specify process is initiated when the other communications device transmits a request signal to the communications device.

Therefore, with the arrangement, the other communications device becomes the source for both the request signal indicating a request for specification of ACK information related to group ACK and the request signal used in the bandwidth information specify process.

Therefore, the other communications device can determine alone when to initiate the ACK information specify process related to group ACK and when to initiate the bandwidth information specify process. Therefore, the processes required to establish downlink stream communications can be done efficiently.

Another communications device in accordance with the present invention, in the foregoing communications device, the response signals also indicate information on a group ACK type desired by the communications device and information on a stream transmit buffer size in the communications device.

Therefore, the response signals transmitted from the communications device (i.e., central control device) to the other communications device also indicate information on an ACK transmission scheme type desired by the communications device and information on a stream transmit buffer size in the communications device.

Therefore, the central control device can notify of information required to complete the ACK information specify process related to group ACK.

Another communications device in accordance with the present invention, as described in the foregoing, is characterized in that it is part of a network system involving multiple communications devices and a communications network connecting the devices. The communications device includes receive means for receiving a first request signal from another communications device so as to establish data communications between the communications device and the other communications device. The first request signal indicates a request for a first communications establish process. The communications device further includes: determine means for determining whether to accept the request in the first request signal; and transmit means for transmitting a second request signal indicating a request for a second communications establish process to the other communications device so as to establish data communications between the communications device and the other communications device. If the determine means has accepted the request, the transmit means transmits the second request signal to the other communications device.

According to the arrangement, the determine means determines whether to accept the request in the first request signal. If the determine means has accepted the request, the transmit means transmits the second request signal to the other communications device.

That is, the transmit means transmits the second request signal on a condition that the communications device has accepted the request.

Therefore, the communications device can by itself determine when to transmit the second request signal. That is, the second communications establish process can also be triggered by the transmission of the first request signal from the other communications device.

Therefore, the processes required to establish data communications can be done efficiently.

Another communications device in accordance with the present invention, in the foregoing communications device, is such that: the communications device is a device for managing a transmission right for the communications network; the data communications is a downlink stream communications from the other communications device to the communications device; the receive means receives a request signal, as the first request signal, indicating a request for a bandwidth information specify process; and the transmit means transmits a request signal, as the second request signal, indicating a request for an ACK information specify process related to group ACK.

According to the arrangement, the communications device determines whether to accept the request in the request signal indicating a request for specification of bandwidth information. If the determine means has accepted the request, the transmit means sends the communications device a request signal indicating a request for specification of ACK information related to group ACK.

That is, the communications device transmits the request signal indicating the request for specification of ACK information on a condition that the request has been accepted.

Therefore, the communications device can by itself determine when to transmit the request signal indicating the request for specification of ACK information related to group ACK. Therefore, the processes required to establish downlink stream communications can be done efficiently.

Another communications device in accordance with the present invention, in the foregoing communications device, further includes: a MAC sublayer for transmitting a request signal indicating a request that the other communications device specify ACK information related to group ACK; and a management layer, provided with the determine means, for managing the MAC sublayer. If the determine means has accepted the request, the management layer issues an instruction to the MAC sublayer to transmit a request signal indicating a request for specification of the ACK information related to group ACK.

Another communications device in accordance with the present invention, as described in the foregoing, is part of a network system involving multiple communications devices and a communications network connecting the devices. The communications device includes: transmit means for transmitting a request signal indicating a request for a predetermined communications establish process to another communications device so as to establish data communications between the communications device and the other communications device; receive means for receiving, from the other communications device, a response signal to the request signal; determine means for determining based on the response signal whether the predetermined communications establish process has been performed; and notify means for notifying the other communications device of a determination made by the determine means.

According to the arrangement, the notify means notifies the other communications device of a determination made by the determine means. That is, the communications device notifies the other communications device whether the first specify process has been done.

Therefore, the other communications device can recognize that the predetermined specify process has been done from the determination. The other communications device can determine when to initiate another communications establish process with respect to the communications device so as to establish data communications. That is, the other communications establish process can also be done by triggering a notification of the determination made by the communications device.

Therefore, the processes required to establish data communications can be done efficiently.

Another communications device in accordance with the present invention, in the foregoing communications device, is characterized in that: the other communications device is a central control device for managing a transmission right for the communications network; the data communications are a downlink stream communications from the other communications device to the communications device; the transmit means transmits a request signal, as the request signal, indicating a request for a bandwidth information specify process; and the determine means determines whether the bandwidth information specify process has been performed.

According to the arrangement, the notify means notifies the other communications device (central control device) of a determination made by the determine means. That is, the communications device notifies the other communications device whether the bandwidth information has been specified.

To enable downlink stream communications, the ACK information specify process and the bandwidth information specify process are needed between the communications device and the other communications device (central control device). Further, the bandwidth information specify process is initiated by transmitting a request signal from the communications device to the central control device. In contrast, the ACK information specify process is initiated by transmitting a request signal from the central control device to the communications device.

Therefore, the other communications device (central control device) recognizes that the bandwidth information specify process has been done. This in turn enables the other communications device to determine a timing for the ACK information specify process. Therefore, the processes required to establish downlink stream communications can be done efficiently.

Another communications device in accordance with the present invention, as described in the foregoing, is part of a network system involving multiple communications devices and a communications network connecting the devices. The communications device includes: receive means for receiving a request signal from another communications device so as to establish data communications between the communications device and the other communications device, the request signal indicating a request for a communications establish process which includes a process of specifying predetermined information; and compare means for comparing the communications device with the other communications device in priority on the basis of the request signal. If the other communications device has higher priority, the communications device transmits a response signal indicating the predetermined information to the other communications device so as to establish data communications between the communications device and the other communications device.

According to the arrangement, if the other communications device has higher priority, the communications device transmits a response signal indicating the predetermined information to the other communications device so as to establish data communications between the communications device and the other communications device.

Therefore, data communications can be performed at the specifications based on the process of specifying the predetermined information sent from the other communications device.

In addition, no request signal or response signal needs be exchanged between the two devices regarding predetermined information not supported by the other communications device, which is given priority. Therefore, data communications can be established by exchanging less request signals and response signals between the two devices than in conventional technology.

Another communications device in accordance with the present invention, as described in the foregoing, is characterized in that it is part of a network system involving multiple communications devices and a communications network connecting the devices. The communications device includes receive means for receiving a request signal from another communications device so as to establish data communications between the communications device and the other communications device. The request signal indicates a request for a communications establish process which includes a process of specifying predetermined information. The communications device further includes compare means for comparing the communications device with the other communications device in priority on the basis of the request signal. If the communications device has higher priority, the communications device transmits a response signal to the other communications device so as to establish data communications between the communications device and the other communications device. The response signal includes a process of specifying information specified by the communications device.

According to the arrangement, if the other communications device has higher priority, the communications device transmits a response signal to the other communications device so as to establish data communications between the communications device and the other communications device. The response signal includes a process of specifying information specified by the communications device.

Therefore, data communications can be performed at the specifications based on the information specified by and transmitted from the communications device.

In addition, no request signal or response signal needs be exchanged between the two devices regarding predetermined information not supported by the communications device, which is given priority. Therefore, data communications can be established by exchanging less request signals and response signals between the two devices than in conventional technology.

Another communications device in accordance with the present invention, in the foregoing communications device, is such that: the communications establish process is an ACK information specify process related to group ACK; and the request signal includes information on group ACK type.

According to the arrangement, data communications can be performed at specifications based on the group ACK type information transmitted from one of the devices with higher priority.

Another communications device in accordance with the present invention, in the foregoing communications device, is such that the request signal includes information as to whether the other communications device from which the request signal originates is a source or a destination in the data communications; the priority is determined based on whether the other communications device from which the request signal originates is a source or a destination in the data communications.

According to the arrangement, the priority is determined based on information as to whether the other communications device from which the request signal originates is a source or a destination in the data communications.

Therefore, either the source or destination in the data communications can be given priority regardless of whether the device in consideration is the source or destination of the request signal.

Another communications device in accordance with the present invention, as described in the foregoing, is characterized in that it is part of a network system involving multiple communications devices and a communications network connecting the devices. The communications device includes: transmit means for transmitting a first request signal to another communications device so as to establish data communications between the communications device and the other communications device; and receive means for receiving a second request signal from the other communications device. The first request signal includes information as to whether the communications device is a source or a destination in the data communications.

According to the arrangement, the first request signal includes information as to whether the communications device is a source or a destination in a stream communications.

Suppose that the aforementioned arrangement where the communications device transmits the first request signal to another communications device and receives the second request signal from the other communications device to enable stream communications between the communications device and the other communications device. In other words, the communications device and the other communications device sends a request signal to each other. The arrangement entails the following problems.

First, if only the source device in the data communications transmits a request signal as in conventional technology, the data flow direction is determinable—from source to destination of the request signal.

However, in the above arrangement where both the communications device and the other communications device can be a source of a request signal, the data flow direction is undeterminable. It may be from source to destination or from destination to source of the request signal. The data flow direction is no uniquely determined.

This problem is addressed by including in the first request signal information as to whether the communications device is the source or destination in the data communications. The inclusion of such information enables the determination of the data flow direction.

A network system in accordance with the present invention includes the communications device and the communications device.

Another network system in accordance with the present invention includes the communications device and another communications device connected to the communications device over a communications network.

Another network system in accordance with the present invention includes the communications device and a central control device, connected to the communications device over a communications network, for managing a transmission right for the communications network.

A communications managing method in accordance with the present invention is for use in a network system including at least one communications device and a central control device connected to the at least one communications device over a communications network. The central control device managing a transmission right for the communications network. The communications managing method involves the sequential steps of: the at least one communications device transmitting a request signal to the central control device so as to establish downlink stream communications from the central control device to the at least one communications device, the request signal indicating a request for an ACK information specify process related to group ACK; the central control device receiving the request signal from the at least one communications device, the request signal indicating a request for an ACK information specify process; the central control device transmitting, to the at least one communications device, a response signal to the request signal indicating a request for an ACK information specify process; and the at least one communications device receiving the response signal from the central control device.

Another communications managing method in accordance with the present invention is for use in a network system including at least one communications device and a central control device connected to the at least one communications device over a communications network. The central control device managing a transmission right for the communications network. The communications managing method involves the sequential steps of: the central control device receiving a request signal from the at least one communications device so as to establish downlink stream communications from the central control device to the at least one communications device, the request signal indicating a request for a bandwidth information specify process; the central control device determining whether to accept the request for a bandwidth information specify process indicated by the request signal; and if the central control device has accepted the request in the preceding step, the central control device transmitting a request signal to the at least one communications device so as to establish the downlink stream communications. The request signal indicates a request for an ACK information specify process related to group ACK.

Another communications managing method in accordance with the present invention is for use in a network system including at least one communications device and a central control device connected to the at least one communications device over a communications network. The central control device managing a transmission right for the communications network. The communications managing method involves the sequential steps of: the at least one communications device transmitting a request signal to the central control device so as to establish downlink stream communications from the central control device to the at least one communications device, the request signal indicating a request for a bandwidth information specify process; the at least one communications device receiving, from the central control device, a response signal to the request signal; the at least one communications device determining from the response signal whether the bandwidth information specify process has been performed; and the at least one communications device notifying the central control device of a determination made in the preceding step.

A request signal in accordance with the present invention is used in a communications managing method whereby one of communications devices connected with each other over a communications network transmits a request signal to another one of the communications devices so as to establish data communications between the communications devices. The request signal is transmitted first in each of multiple communications establish processes performed between the communications devices. The request signal includes information based on which the data communications are established. The information is required when the one of communications devices acts as any one of a source device, a destination device, and a central control device for managing a communications right for the network in the data communications.

Another request signal in accordance with the present invention is a request signal in a network system including at least one communications device and a central control device connected to the at least one communications device over a communications network. The central control device manages a transmission right for the communications network. The request signal is transmitted from the at least one communications device to the central control device. The request signal enables establishment of downlink stream communications from the central control device to the at least one communications device. The request signal includes information being required so that the at least one communications device which is a destination of streaming data specifies ACK information related to group ACK.

A response signal in accordance with the present invention is a response signal in a communications managing method whereby: one of communications devices connected with each other over a communications network transmits a request signal to another one of the communications devices so as to establish data communications between the communications devices. The request signal is transmitted first in each of multiple communications establish processes performed between the communications devices. The other communications devices transmits, to the one of communications devices, a response signal to the request signal. The response signal includes information being required when the other communications device acts as any one of a source device, destination device, and a central control device managing a communications right for the network in the data communications. The response signal enables establishment of the data communications.

Another response signal in accordance with the present invention is transmitted from a central control device connected to at least one communications device over a communications network to the at least one communications device. The central control device manages a transmission right for the communications network. The response signal is made in response to a request signal enabling establishment of downlink stream communications from the central control device to the at least one communications device. The response signal includes information enabling the central control device which is a source of streaming data to specify ACK information related to group ACK.

A computer program in accordance with the present invention causes a computer to function as the means of the communications device to solve the problems.

Loaded onto a computer system, the program can provide the user with the communications device.

Another computer program in accordance with the present invention, as described in the foregoing, causes a computer to execute the communications managing method.

Loaded onto a computer system, the program can provide the user with the communications managing method.

A storage medium in accordance with the present invention, as described in the foregoing, contains the computer program.

As the program contained in the storage medium is loaded onto a computer system, the program can provide the user with the communications device, the central control device, or the communications managing method.

The communications managing method in accordance with the present invention may be described as being used in a communications system including at least one communications station and a central control station and as involving a step of the at least one communications station transmitting an ACK information specify request when the central control station is to transmit a downlink stream to the at least one communications station.

This can be translated into each of the ADDGA request frame and the ADDGA response frame provided with both a field for information communicated from the stream transmitting station to the stream receiving station and a field for information communicated from the stream receiving station to the stream transmitting station.

The communications managing method in accordance with the present invention may also be described as the ACK information specify request including at least one of an ACK transmission scheme desired by the communications station and information on the packet receive buffer size in the communications station.

This can be translated into the group ACK policy and re-ordering buffer size being communicated from the stream receiving station to the stream transmitting station by transmitting an ADDGA request frame.

The communications managing method in accordance with the present invention may also be described as the downlink stream being managed based on the ACK transmission scheme and the information on the packet receive buffer size in the communications station included in the ACK information specify request.

This can be translated into the group ACK being transmitted based on the group ACK policy and the re-ordering buffer size communicated by the ADDGA request frame.

Accordingly, ADDTS can be triggered by the stream receiving station. A single station can initiate both ADDTS and ADDGA. Problem A and problem B are hence solved.

The communications managing method in accordance with the present invention may also be described as being used in a communications system including at least one communications station and a central control station and involving a step of the at least one communications station transmitting a bandwidth information specify request when the central control station is to transmit a downlink stream to the at least one communications station, a step of the central control station receiving the bandwidth information specify request, and a step of the central control station transmitting an ACK information specify request to the at least one communications station when the transmission of the downlink stream is to be triggered upon reception of the bandwidth information specify request.

The communications managing method in accordance with the present invention may also be described as the communications managing method wherein the trigger is communicated from an MAC-layer-managing layer to another layer.

This can be translated into a bandwidth management section on an HC having received the ADDTS request frame returning an ADDTS response frame to a non-AP QSTA and notifying an application triggering ADDGA of a success/failure of ADDTS, so that the application can initiate the ADDGA with the non-AP QSTA.

Accordingly, the ADDGA-triggering application can first check the success/failure of the ADDTS before initiating ADDGA. Problem A and problem B are hence solved.

The communications managing method in accordance with the present invention may also be described as being used in a communications system including at least one communications station and a central control station and involving a step of the at least one communications station notifying the central control station of the success of a bandwidth information specify request when the central control station is to transmit a down stream to the at least one communications station or a step of the central control station notifying the at least one communications station of the success of an ACK information specify request.

This can be translated into the non-AP QSTA having received an ADDTS response frame notifying the HC of a success/failure of ADDTS.

Accordingly, the ADDGA-triggering-application can first check the success/failure of the ADDTS before initiating ADDGA. Problem A and problem B are hence solved.

The central control station in accordance with the present invention may also be described as managing communications by one of the foregoing communications managing methods.

The communications station in accordance with the present invention may also be described as managing communications by one of the foregoing communications managing methods.

The communications manage computer program in accordance with the present invention executes procedures by one of the foregoing communications managing methods.

The communications manage computer program in accordance with the present invention executes procedures by one of the foregoing communications managing methods.

The computer-readable storage medium containing a communications managing program in accordance with the present invention contains the communications managing program.

The communications station in accordance with the present invention may also be described as operating by a communications method requiring an exchange of a request signal and a response signal so as to complete communications setup for a downlink stream between two communications stations and having means for, if the communications station is acting as the receiving station in a data transmission, transmitting a request signal to the transmitting station in the data transmission.

The request signal in accordance with the present invention may also be described as being used in a communications method whereby two communications stations of different attributes which require an exchange of a request signal and a response signal can transmit a request signal so as to complete communications setup between the two communications stations, and being capable of including information needed to complete the communications setup regarding the attributes the communications stations can have in the individual attributes.

Here, “data transmission” encompasses “stream transmission.” An attribute means a role assigned to a communications station regardless whether the station is the source of a request signal or the source of a response signal, for example, whether the station is the transmitting station or the receiving station of a stream or the central control station.

The communications station in accordance with the present invention may also be described as operating by a communications method requiring an exchange of a request signal and a response signal so as to complete communications setup for a downlink stream between two communications stations and having means for, if the communications station is the transmitting station in a data transmission, transmitting a response signal to the transmitting station in a data transmission.

The response signal in accordance with the present invention may also be described as being used in a communications method whereby two communications stations of different attributes which require an exchange of a request signal and a response signal can transmit a request signal so as to complete communications setup between the two communications stations, and being capable of including information needed to complete the communications setup regarding the attributes the communications station can have in the individual attributes.

The communications station in accordance with the present invention may also be described as being part of a communications system including at least one communications stations and a central control station and having means to transmit a request signal for specification of ACK information when the central control station is to carry out a communications setup for a downlink stream with the communications station.

The communications station in accordance with the present invention may also be described as, in the communications station, transmitting, among other data, at least one of an ACK transmission scheme desired by the communications station and information on a stream receive buffer size in the communications station in a request signal for specification of ACK information.

The central control station in accordance with the present invention may also be described as being part of a communications system including at least one communications station and a central control station and as having means for interpreting a request signal for specification of ACK information and transmitting a response signal thereto for the specification of ACK information when the central control station is to carry out a communications setup for a downlink stream with the communications station.

The central control station in accordance with the present invention may also be described as, in the central control station, transmitting, among other data, at least one of an ACK transmission scheme desired by the central control station and information on a stream transmit buffer size in the central control station in a response signal for specification of ACK information.

The communications station in accordance with the present invention may also be described as operating by a communications scheme whereby a request signal including information upon which two communications stations should agree and a response signal including information upon which the two communications stations should agree are exchanged to select a value from two or more values as information that should be agreed upon, and having means for, if the source of the request signal has higher priority than the communications station when a request signal has been received, interpreting the value included in the request signal as information that should be agreed upon as being the value that has been agreed upon with the counterpart communications station and transmitting an identical value to the value included in the request signal as information that should be agreed upon in the response signal as information that should be agreed upon.

The communications station in accordance with the present invention may also be described as operating by a communications scheme whereby a request signal including information upon which two communications stations should agree and a response signal including information upon which the two communications stations should agree are exchanged to select a value from two or more values as information that should be agreed upon, and having means for, if the source of the request signal has lower priority than the communications station when a request signal has been received, interpreting the value desired by the communications stations as the value that has been agreed upon with the counterpart communications station and transmitting the value desired by the communications stations in the response signal as information that should be agreed upon.

The communications station in accordance with the present invention may also be described as operating by a communications scheme whereby a request signal including information upon which two communications stations should agree and a response signal including information upon which the two communications stations should agree are exchanged to select a value from two or more values as information that should be agreed upon, and having means for interpreting the value included in the response signal as information that should be agreed upon as being the information that has been agreed upon with the counterpart communications station.

Note that this is irrelevant to whether the source of a transmission has higher or lower priority than the communications station.

The communications station in accordance with the present invention may also be described as the communications station wherein the information that should be agreed upon is an ACK transmission scheme.

The communications station in accordance with the present invention is the communications station having means for transmitting the priority of the communications station in the request signal.

The communications station in accordance with the present invention may also be described as being the communications station wherein the priority is determined according to whether the station is a stream transmitting station or a stream receiving station.

The communications station in accordance with the present invention may also be described as a communications station wherein a signal exchange of 2 or more units as to a signal exchange with an exchange of one request signal and one response signal as a unit are needed to complete a communications setup between two communications stations, and as to the first signal exchange and the second signal exchange among them, the source station of a request signal in the first signal exchange and the source station of a request signal in the second signal exchange observe different communications schemes, and a lower layer than the application has means for the lower layer than the application initiate a transmission of a request signal in the second signal exchange as triggered by the communications station having accepted a request in the first signal exchange.

The central control station in accordance with the present invention may also be described as a central control station in a communications system including at least one communications station and a central control station and having means for, when the central control station is to carry out a communications setup for a downlink stream with the communications station, receiving a request signal for specification of bandwidth information from the communications station and means for transmitting, to the communications station, a request signal for specification of ACK information when a downlink stream is transmitted as triggered by the communications station having accepted a request by a request signal for specification of bandwidth information.

The central control station in accordance with the present invention may also be described as being the central control station wherein the trigger is communicated from an MAC-layer-managing layer to another layer.

The communications station in accordance with the present invention may also be described as a communications station wherein a signal exchange of 2 or more units as to a signal exchange with an exchange of one request signal and one response signal as a unit are needed to be done in a predetermined sequence to complete a communications setup between two communications stations, and as to the first and second consecutive signal exchanges among them, a request signal in the first signal exchange and the source station of a request signal in the second signal exchange observe different communications schemes, and the communications station has means for instructing to initiate the second signal exchange with the source station the request signal in the second signal exchange as triggered by receipt of the response signal in the first signal exchange.

The communications station in accordance with the present invention may also be described as operating by a communications managing method in a communications system including at least one communications station and a central control station and having means for notifying the central control station whether a bandwidth information specify request has been a success when the central control station is to carry out a communications setup for a downlink stream with the communications station.

The communications station in accordance with the present invention may also be described as being a communications station in a communications system including two or more communications stations, being a communications station operating by a communications method whereby two communications stations need an exchange of a request signal and a response signal to complete a stream transmission setup between the two communications stations and possibly transmit a request signal, and a stream is identified in the whole communications system by the stream transmitting station giving a unique identifier, and having means for transmitting information as to whether the communications station is the transmitting station or the receiving station for the stream to be set up in a request signal in a setup of a stream transmission.

The communications station in accordance with the present invention may also be described as being a communications station in a communications system including two or more communications stations, being a communications station operating by a communications method whereby two communications stations need an exchange of a request signal and a response signal to complete a stream transmission setup between the two communications stations and possibly transmit a request signal, and a stream is identified in the whole communications system by the stream transmitting station giving a unique identifier, and having means for identifying a stream which is a target for the request signal from the stream identifier and information as to whether the source of the request signal included in request signal in a stream transmission setup is the transmitting station or the receiving station of the stream to be set up.

The communications managing program in accordance with the present invention causes a computer to execute procedures of the communications managing method.

The computer-readable storage medium in accordance with the present invention contains the communications managing program.

### INDUSTRIAL APPLICABILITY

The invention is applicable to communications devices and network systems where a communications establish process needs be done to establish data communications.

1. A communications device which is part of a network system involving multiple communications devices and a communications network connecting the devices,
said communications device comprising transmit means for transmitting signals from said communications device to another communications device, said signals being transmitted first in respective communications establish processes performed between said communications device and the other communications device so as to establish data communications between said communications device and the other communications device.

2. The communications device of claim 1, wherein:
the other communications device is a central control device for managing a transmission right for the communications network;
the data communications are a downlink stream communications from the other communications device to said communications device; and
the transmit means transmits a request signal, as said signals, to the other communications device, the request signal indicating a request for an ACK information specify process related to group ACK to establish the downlink stream communications.

3. The communications device of claim 2, wherein the request signal also indicates information on a group ACK type desired by said communications device and information on a stream receive buffer size in said communications device.

4. A communications device which is part of a network system involving multiple communications devices and a communications network connecting the devices,
said communications device comprising:
receive means for receiving signals from another communications device, said signals being transmitted first in respective communications establish processes performed between said communications device and the other communications device so as to establish data communications between said communications device and the other communications device; and
transmit means for transmitting, to the other communications device, response signals respectively to said signals which are transmitted first.

5. The communications device of claim 4, wherein:
said communications device is a device for managing a transmission right for the communications network;
the data communications is a downlink stream communications from said communications device to the other communications device; and
the receive means receives a request signal, as said signals, from the other communications device, the request signal indicating a request for an ACK information specify process related to group ACK to establish the downlink stream communications.

6. The communications device of claim 5, wherein the response signals also indicate information on a group ACK type desired by said communications device and information on a stream transmit buffer size in said communications device.

7. A communications device which is part of a network system involving multiple communications devices and a communications network connecting the devices,
said communications device comprising:
receive means for receiving a first request signal from another communications device so as to establish data communications between said communications device and the other communications device, said first request signal indicating a request for a first communications establish process;
determine means for determining whether to accept the request in the first request signal; and
transmit means for transmitting a second request signal indicating a request for a second communications establish process to the other communications device so as to establish data communications between said communications device and the other communications device,
wherein if the determine means has accepted the request, the transmit means transmits the second request signal to the other communications device.

8. The communications device of claim 7, wherein:
said communications device is a device for managing a transmission right for the communications network;
the data communications is a downlink stream communications from the other communications device to said communications device;
the receive means receives a request signal, as the first request signal, indicating a request for a bandwidth information specify process; and
the transmit means transmits a request signal, as the second request signal, indicating a request for an ACK information specify process related to group ACK.

9. The communications device of claim 8, further comprising:
a MAC sublayer for transmitting a request signal indicating a request that the other communications device specify ACK information related to group ACK; and
a management layer, provided with the determine means, for managing the MAC sublayer,
wherein if the determine means has accepted the request, the management layer issues an instruction to the MAC sublayer to transmit a request signal indicating a request for specification of the ACK information related to group ACK.

10. A communications device which is part of a network system involving multiple communications devices and a communications network connecting the devices,
said communications device comprising:
transmit means for transmitting a request signal indicating a request for a predetermined communications establish process to another communications device so as to establish data communications between said communications device and the other communications device;
receive means for receiving, from the other communications device, a response signal to the request signal;
determine means for determining based on the response signal whether the predetermined communications establish process has been performed; and
notify means for notifying the other communications device of a determination made by the determine means.

11. The communications device of claim 10, wherein:
the other communications device is a central control device for managing a transmission right for the communications network;
the data communications are a downlink stream communications from the other communications device to said communications device;
the transmit means transmits a request signal, as the request signal, indicating a request for a bandwidth information specify process; and
the determine means determines whether the bandwidth information specify process has been performed.

12. A communications device which is part of a network system involving multiple communications devices and a communications network connecting the devices,
said communications device comprising:
receive means for receiving a request signal from another communications device so as to establish data communications between said communications device and the other communications device, the request signal indicating a request for a communications establish process which includes a process of specifying predetermined information; and
compare means for comparing said communications device with the other communications device in priority on the basis of the request signal,
wherein if the other communications device has higher priority, said communications device transmits a response signal indicating the predetermined information to the other communications device so as to establish data communications between said communications device and the other communications device.

13. A communications device which is part of a network system involving multiple communications devices and a communications network connecting the devices,
said communications device comprising:
receive means for receiving a request signal from another communications device so as to establish data communications between said communications device and the other communications device, the request signal indicating a request for a communications establish process which includes a process of specifying predetermined information; and
compare means for comparing said communications device with the other communications device in priority on the basis of the request signal,
wherein if said communications device has higher priority, said communications device transmits a response signal to the other communications device so as to establish data communications between said communications device and the other communications device, the response signal including a process of specifying information specified by said communications device.

14. The communications device of claim 12 wherein:
the communications establish process is an ACK information specify process related to group ACK; and
the request signal includes information on group ACK type.

15. The communications device of claim 12, wherein:
the request signal includes information as to whether the other communications device from which the request signal originates is a source or a destination in the data communications;
the priority is determined based on whether the other communications device from which the request signal originates is a source or a destination in the data communications.

16. A communications device which is part of a network system involving multiple communications devices and a communications network connecting the devices,
said communications device comprising:
transmit means for transmitting a first request signal to another communications device so as to establish data communications between said communications device and the other communications device; and
receive means for receiving a second request signal from the other communications device so as to establish data communications between said communications device and the other communications device,
wherein the first request signal indicates information as to whether said communications device is a source or a destination in the data communications.

17. A network system, comprising:
the communications device of claim 1; and
a communications device which is part of a network system involving multiple communications devices and a communications network connecting the devices,
said communications device comprising:
receive means for receiving signals from another communications device, said signals being transmitted first in respective communications establish processes performed between said communications device and the other communications device so as to establish data communications between said communications device and the other communications device; and
transmit means for transmitting, to the other communications device, response signals respectively to said signals which are transmitted first.

18. A network system, comprising:
the communications device of claim 7; and
another communications device connected to the communications device over the communications network.

19. A network system, comprising:
the communications device of claim 10; and
a central control device, connected to the communications device over the communications network, for managing a transmission right for the communications network.

20-29. (canceled)

30. The communications device of claim 1, wherein said signals being transmitted first indicate information based on which the data communications are established, the information being required when said one of communications devices acts as any one of a source device, a destination device, and a central control device for managing a communications right for the network in the data communications.

31. The communications device of claim 1, wherein: said signals being transmitted first are transmitted from the at least one communications device to the central control device for managing the network, and are request signals enabling establishment of downlink stream communications from the central control device to the at least one communications device; and
said signals being transmitted first indicate information being required so that the at least one communications device which is a destination of streaming data specifies ACK information related to group ACK.

32. The communications device of claim 4, the response signal indicating information being required when said one of communications device acts as any one of a source device, destination, and a central control device managing a communications right for the network in the data communications, the information enabling establishment of the data communications.

33. The communications device of claims 4, the response signal being made in response to a request signal enabling establishment of downlink stream communications from the central device to the at least one communications device,
the response signal indicating information enabling the central control device which is a source of streaming data to specify ACK information related to group ACK.

34. A computer program causing a computer to function as the means of the communications device of any one of claims 1, 4, 7, 10, 12, 13 or 16.

35. A storage medium containing the computer program of claim 34.
